(19) United States
(12) Patent Application Publication
(10) Pub. No.: US 2019/0092080 A1
(43) Pub. Date: Mar. 28, 2019

(54) SECURITY DOCUMENT COMPRISING A POLYMER SUBSTRATE

(71) Applicant: DE LA RUE INTERNATIONAL LIMITED, Basingstoke Hampshire (GB)

(72) Inventor: Matthew SUGDON, Basingstoke Hampshire (GB)

(73) Assignee: DE LA RUE INTERNATIONAL LIMITED, Basingstoke Hampshire (GB)

(21) Appl. No.: 16/086,870

(22) PCT Filed: Mar. 22, 2017
(86) PCT No.: PCT/GB2017/050803

§ 371 Date: Sep. 20, 2018

(30) Foreign Application Priority Data
Mar. 23, 2016 (GB) 1604947.0
Jun. 10, 2016 (GB) 1610180.0

(51) Int. Cl. B42D 25/24; B42D 25/351

(52) U.S. Cl. CPC B42D 25/24; B42B 2/00; B42D 25/351

(57) ABSTRACT

A security document and methods of manufacturing are provided. The security document includes a first polymer page adjacent to a second polymer page. The first polymer page has a first polymer substrate and the second polymer page has a second polymer substrate. The first polymer substrate is of a different structure and/or material than the second polymer substrate. The second polymer page is thicker than the first polymer page.

### CROSS REFERENCE TO RELATED APPLICATIONS

This application is a 35 U.S.C. § 371 national stage entry of PCT Application PCT/GB2017/050803, filed on Mar. 22, 2017, which in turn claims the benefit under 35 U.S.C. § 119(a) of United Kingdom Application No. GB1604947.0, filed Mar. 23, 2016, and United Kingdom Application No. GB1610180.0, filed Jun. 10, 2016 the entire contents of each of which are incorporated by reference herein in their entirety.

### BACKGROUND OF THE DISCLOSURE

### 1. Field of the Disclosure

The present disclosure is directed towards a security document comprising a first polymer page adjacent to a second polymer page. The present disclosure is further directed towards a security document comprising a polymer page attached adjacent to at least one further page. The further page may comprise a fibrous substrate or a polymer. The present disclosure is further directed towards methods of manufacturing such security documents and a plurality of such security documents.

### 2. Description of the Related Art

Security documents and booklets, such as passports, passbooks, identification documents, certificates, licenses, cheque books and the like, commonly comprise one or more security pages on which information is provided. A passport booklet typically comprises a cover and a plurality of internal visa pages therebetween. Typically the visa pages are made from paper having a grammage of around 85 gsm and are sewn together along a stitch line. The cover is adhered to the outside of the visa pages and thereby protects the stitch line. At least one data page is typically located between one of the visa pages and the cover and contains printed personal data overlaid by a layer of polymer laminate, which is usually applied as a film or lacquer. This layer helps protect the data and prevent counterfeiting and fraudulent alteration. The data page may be formed from a fibrous substrate and may comprise security features, such as watermarks, laser perforations, security fibres, security threads, security print and the like.

Alternatively, the data page may be formed from a sheet comprising a plastic, which is typically polycarbonate. Plastic data pages are more durable than fibrous substrate data pages and are resistant to delamination by a counterfeiter. A plastic security sheet may comprise various security features, such as UV responsive arrangements, optically variable features, windowed or transparent features, laser-perforations, laser markings and tactile features.

During manufacture a number of thin plastic layers are laid over one another and fused together, thereby forming a thicker plastic sheet. The most common method of fusing the thinner plastic layers together involves placing them in between a “sandwich” of steel or brass laminating plates and heating the thinner plastic layers through the laminating plates. However, such a method is relatively time inefficient with each heating cycle taking around 30 minutes and can lead to uneven fusing and quality of the plastic sheets due to varying temperature and pressure distribution throughout the stack. An alternative, semi-continuous, method of manufacturing plastic data pages for security documents is disclosed in U.S. Pat. No. 6,669,813. The thin plastic layers are brought together before being incrementally conveyed between two opposing continuous belts through a series of heating and cooling devices. A section of the thin plastic layers is initially kept stationary by the continuous belts and the layers are heated and pressed together under pressure by the heating devices such that they fuse into a plastic sheet. After a certain amount of time, typically less than a minute, the continuous belts move the section to between the cooling devices where it is cooled and pressure is again applied, typically for less than a minute. The resulting plastic sheets are substantially uniform in quality.

### SUMMARY

However, new and improved security features must be developed in order for security document issuing authorities to keep ahead of counterfeiting methods.

The present invention is therefore generally directed towards the incorporation of a polymer substrate, which is preferably substantially flexible, into a multi-page security document. Such flexible polymer substrates are commonly used to form “polymer” banknotes and can contain a variety of security features. Objects of the present invention include overcoming difficulties in the incorporation of the flexible polymer substrate into a multi-page security document and enhancing the security of security documents comprising the flexible polymer substrate. A further object is to provide an improved method of manufacture of the security document including the flexible polymer substrate.

The present invention therefore provides a security document comprising a first polymer page adjacent to a second polymer page, the first polymer page comprising a first polymer substrate and the second polymer page comprising a second polymer substrate, wherein the first polymer substrate is of a different structure and/or material to the second polymer substrate. The second polymer page may be thicker than the first polymer page.

The first polymer substrate is more durable than a fibrous substrate security sheet and is resistant to delamination by a counterfeiter. Furthermore, the first polymer substrate is thinner than a polycarbonate based data page and thus creates a more compact security document. Various different security features and devices may also be included in the first polymer substrate to increase the difficulty of counterfeiting it, whether by virtue of the security features alone or due to their interaction with security pages on adjacent pages.

The first polymer substrate may be a flexible film, whilst the second polymer substrate may be a rigid sheet. In other words, preferably the second polymer substrate and/or second polymer page is more rigid, is less flexible, is stiffer or has a higher bending stiffness than the first polymer substrate and/or second polymer page. In particular, the second polymer substrate is substantially thicker, preferably at least twice as thick and more preferably at least three times as thick, and more rigid than the first polymer substrate. Furthermore, at least one opacifying layer is typically located on the outside of the first polymer substrate and the first polymer substrate may contain no opacifying region or layer within it. However, as the second polymer substrate is usually thicker, it may include an opaque region formed from at least one opaque plastic layer or filler fused within the second polymer substrate and separated from the outer surfaces of the second polymer substrate. In a particularly preferred embodiment the first polymer substrate comprises a Biaxially Oriented Polypropylene (BOPP) film and the second polymer substrate comprises a polycarbonate sheet.

The present invention further provides a plurality of such security documents and a method of manufacturing the aforementioned security document as set out in the claims. The present disclosure also provides such a security document, as an alternative to the second polymer page being thicker than the first polymer page, wherein the second polymer substrate is thicker than the first polymer substrate.

The present invention yet further provides a security document comprising a polymer page adjacent to at least one further page, wherein the polymer page comprises a polymer substrate and at least one opacifying layer on at least one surface of the polymer substrate, the at least one opacifying layer being omitted in at least one localised region to form at least one window such that, when the polymer page and at least one further page are arranged to overlie one another, the adjacent further page is visible in the at least one window when the polymer page is viewed in reflected light. The present invention further provides a plurality of such security documents and a method of manufacturing a security document as set out in the claims.

### BRIEF DESCRIPTION OF THE DRAWINGS

By way of example only, embodiments of a security document and a method of manufacture in accordance with the present invention are now described with reference to, and as shown in, the accompanying drawings, in which:

FIG. 1 is a perspective view of a passport according to the present invention in an open configuration;

FIG. 2 is a plan view of the passport of FIG. 1 opened between a first polymer page and an adjacent page;

FIG. 3 is a cross-sectional side elevation of the first polymer page of FIG. 2 through section A-A;

FIG. 4 is a plan view of the passport of FIG. 2 opened between the first polymer page and a cover;

FIG. 5 is a perspective view of a further embodiment of a passport according to the present invention opened between first and second polymer pages;

FIG. 6 is a perspective view of the passport of FIG. 5 opened between a first polymer page and an adjacent page;

FIG. 7 is a cross-sectional side elevation of the second polymer page of FIG. 5 through section B-B;

FIG. 8 is a plan view of the passport of FIG. 5 opened between the second polymer page and a cover;

FIG. 9 is a schematic cross-sectional side elevation of a fold line area of the passport of FIG. 5;

FIG. 10 is a schematic of apparatus for forming a first polymer page of the security document of the present invention;

FIG. 11 is a cross-sectional side elevation of a plurality of plastic layers prior to being laminated into a second polymer substrate for forming a second polymer page of the security document of the present invention;

FIG. 12 is a cross-sectional side elevation of an apparatus for use in a method of manufacturing a second polymer page of the security document of the present invention from the plurality of plastic layers of FIG. 11;

FIG. 13 is a plan view of a further embodiment of a passport of the present invention opened between an adjacent page and a first second polymer page;

FIG. 14 is a cross-section side elevation of first and second polymer pages of the passport of FIG. 13 through section C-C;

FIG. 15 is a plan view of a further embodiment of a passport of the present invention opened between an adjacent page and a first second polymer page;

FIG. 16 is a cross-section side elevation of first and second polymer pages of the passport of FIG. 24 through section D-D;

FIG. 17 is a plan view of a further embodiment of a passport of the present invention opened between an adjacent page and a first polymer page;

FIG. 18 is a plan view of the passport of FIG. 17 opened between first and second polymer pages;

FIG. 19 is a plan view of the passport of FIG. 17 opened between the second polymer page and a cover;

FIG. 20 is a cross-section side elevation of an adjacent page and first and second polymer pages of the passport of FIG. 19 through section E-E;

FIG. 21 is a cross-sectional side elevation of an adjacent page and first and second polymer pages of a further embodiment of the security document of the present invention wherein the first polymer page comprises a focusing element array;

FIG. 22 is a cross-sectional side elevation of an adjacent page and first and second polymer pages of a further embodiment of the security document of the present invention wherein the first polymer page comprises a focusing element array;

FIG. 23 is a cross-sectional side elevation of an adjacent page and first and second polymer pages of a further embodiment of the security document of the present invention wherein the second polymer page comprises a focusing element array; and

FIG. 24 is a cross-sectional side elevation of an adjacent page and first and second polymer pages of a further embodiment of the security document of the present invention.

### DETAILED DESCRIPTION OF THE DISCLOSURE

### A. The Security Document

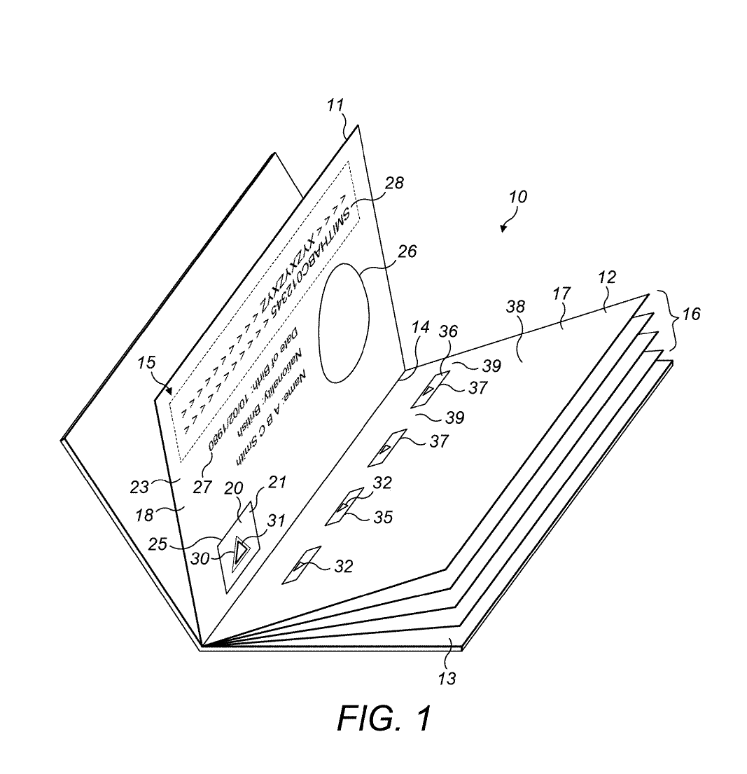

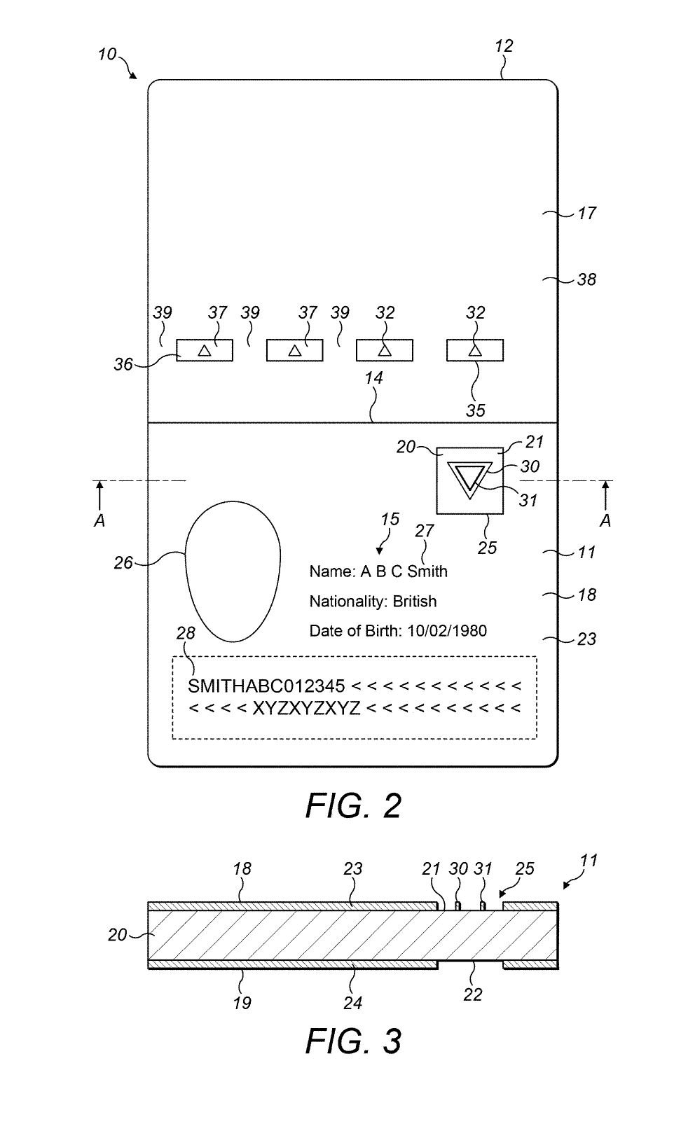

FIGS. 1 to 4 illustrate a security document 10 according to the present invention. The security document 10 in this case is a passport and comprises a first polymer page 11, an adjacent page 12 adjacent to the first polymer page 11 and a cover 13 attached together at edges such that they can pivot relative to one another. In the illustrated embodiment pages 11, 12 and cover 13 are attached along a fold line 14, which may be referred to as a hinge. The first polymer page 11 is, in this example, a data page which contains personal data 15 relating to the owner of the security document 10. The adjacent page 12 forms one of a plurality of visa pages 16, which are typically made from a fibrous substrate 17, such as paper, and may include a number of security features, such as security fibres and watermarks.

As illustrated in further detail in FIG. 3, the first polymer page 11 extends between first and second outer surfaces 18, 19 and comprises a first polymer substrate 20. The first polymer substrate 20 forms a main body of the first polymer page 11 and has first and second substrate surfaces 21, 22. The first polymer substrate 20 is preferably transparent such that a viewer can clearly see objects through it. However, the first polymer substrate 20 may be colourless or coloured, provided that it allows light to pass through it without significant scattering. The thickness of the first polymer substrate 20 is preferably in the range of from approximately 50 μm to approximately 100 μm, more preferably from approximately 60 μm to approximately 80 μm and most preferably approximately 70 μm.

The first polymer substrate 20 is formed from one or more polymeric materials, preferably a plastic and more preferably a thermoplastic. The polymeric materials may be synthetic and may, for example, comprise at least one of polypropylene (PP), bi-axially oriented PP (BOPP), polybutylene terephthalate (PBT), polyethylene terephthalate (PET), polyethylene (PE), polycarbonate (PC), polyvinyl chloride (PVC), nylon, acrylic, Cyclic Olefin Polymer (COP) or Cyclic Olefin Copolymer (COC). Suitable blends thereof include Teslin® and a blend of PE and PP. BOPP is particularly suitable. The first polymer substrate 20 may be non-fibrous and may be non-porous. The first polymer substrate 20 may be monolithic and formed from a single type of material or may be multi-layered and have multiple layers of the same or different types of polymer.

At least one opacifying layer 23, 24 is located on the first and/or second substrate surface 21, 22 and defines or surrounds at least one window 25 of the first polymer page 11. The first polymer substrate 20 may contain no opacifying region or layer within it. The at least one opacifying layer 23, 24 is substantially opaque to substantially prevent light transmitting through the first polymer page 11. The at least one opacifying layer 23, 24 comprises a substantially non-transparent material and provides a suitable background for graphics and the personal data 15 located on it. The at least one opacifying layer 23, 24 may comprise a polymeric, non-fibrous material containing at least a light scattering substance such as a pigment. For example, the at least one opacifying layer 23, 24 may comprise a resin, such as a polyurethane based resin, polyester based resin or an epoxy based resin, and an opacifying pigment, such as titanium dioxide, silica, zinc oxide, tin oxide, clays or calcium carbonate. The at least one opacifying layer 23, 24 is preferably light in colour, most preferably white or another light colour such as off-white or grey for providing a suitable contrast to darker graphics and personal data 15. Therefore, preferably the at least one opacifying layer 23, 24 has a lightness L* in CIE L*a*b* colour space of at least 70, preferably at least 80 and more preferably at least 90.

The at least one opacifying layer 23, 24 preferably covers at least a majority of the first and/or second substrate surface 21, 22. In the illustrated embodiment first and second opacifying layers 23, 24 cover all of the first and second substrate surfaces 21, 22 other than in corresponding or opposing localised areas to form a “full” window 25 of the first polymer page 11. The full window 25 is substantially transparent by virtue of being formed from just the transparent first polymer substrate 20. The at least one window 25 in the illustrated embodiment has a square shaped perimeter.

The first polymer page 11 may further comprise an intermediate layer (not shown in the drawings) between the first and/or second substrate surface 21, 22 of the first polymer substrate 20 and the first and/or second opacifying layer 23, 24. The intermediate layer may comprise a primer layer for improving adhesion of the at least one opacifying layer 23, 24 with the first polymer substrate 20. The primer layer is preferably also transparent and colourless, although it could be coloured or carry another optically detectable material. The primer layer may comprise at least one of polyethylene imine, hydroxyl terminated polymers, hydroxyl terminated polyester based co-polymers, cross-linked or uncross-lined hydroxylated acrylates, polyurethanes and UV curing anionic or cationic acrylates.

The personal data 15, preferably comprising a plurality of alphanumeric characters, is located in or on the first and/or second opacifying layer 23, 24. The personal data 15 may include, for example, the holder's portrait 26, text 27 providing the holder's name, nationality and date of birth and a machine readable zone 28 containing data for machine reading.

The personal data 15 may be incorporated into the first polymer page 11 in any suitable manner, for example by comprising a printed ink. Preferably the personal data 15 is applied to the at least one opacifying layer 23, 24 by UV cure inkjet printing. Further alternatives are discussed below.

The first polymer page 11 may also comprise a number of other security features within the first polymer substrate 20 and/or on the at least one opacifying layer 23, 24 for authenticating the security document 10. A layer of graphics may also be provided on the at least one opacifying layer 23, 24, around or underneath the personal data 15. The graphics may comprise printed ink and may be in the form of non-variable data which is the same across a plurality of security documents 10. The graphics may comprise secure fine line patterns such as guilloches and may comprise patterns, indicia, symbols, logos (such as that of the issuing authority of the security document 10), microtext or the like.

The first polymer page 11 further comprises at least one first security device 30, which may be at least partially located in the window 25 or, alternatively, located outside of the window 25. In the illustrated embodiment the first security device 30 comprises a first element 31 located entirely in the window 25. The at least one first security device 30 may be located on the first substrate surface 21 or at least partially or fully embedded within the first polymer substrate 20 or located on the second substrate surface 22. In the illustrated embodiment the first element 31 is printed on the first substrate surface 21 and the perimeter of the first element 31 is in the shape of a hollow triangle. Various other embodiments of the first security device 30 are discussed in further detail below.

The first polymer page 11 is substantially flexible, particularly by virtue of the relative thinness of the first polymer substrate 20. The thickness of the first polymer page 11, which is the distance between the first and second outer surfaces 18, 19 (i.e. including the first polymer substrate 20 and at least one opacifying layer 23, 24), is preferably in the range of from approximately 50 μm to approximately 200 μm and more preferably in the range of from approximately 50 μm to approximately 150 μm.

The adjacent page 12 comprises at least one second security device 35 and the at least one second security device 35 comprises at least one second element 32. The second security device 35 may be applied and adhered to the opposing surface 38 or it may be at least partially embedded therein in any manner known in the art. In the illustrated embodiment the at least one second security device 35 comprises a security thread 36 incorporated in or applied to the fibrous substrate 17, having at least one exposed region 37 at a surface 38 of the fibrous substrate 17 opposing the first polymer page 11. In the illustrated embodiment the security thread 36 is partially embedded, so that parts thereof are covered by a plurality of bridges 39 in the fibrous substrate 17, for example as disclosed in WO-00/39391, EP-A-0059056 and WO-A-2004/001130. The security thread 36 may, alternatively, be continuously exposed at one surface, so the exposed region 37 extends across the entire adjacent page 12. Suitable materials for forming the security thread 36 include polyethylene terephthalate (PET), oriented polypropylene (OPP), polyethylene (PE) or polyketone (PK). These materials may form a base substrate upon which a metallised layer, print or other security feature can be provided. The security thread 36 is preferably between approximately 1 mm and 20 mm wide.

The at least one second element 32 is located on the exposed region 37 of the security thread 36. The second element 32 may comprise a print on the security thread 36, a demetallised portion of the security thread 36 or any other suitable marking therein or thereon. In the illustrated embodiment the perimeter of the second element 32 is in the shape of a solid triangle which is smaller than the triangle of the first element 31. Various other embodiments of the second security device 35 are discussed in further detail below.

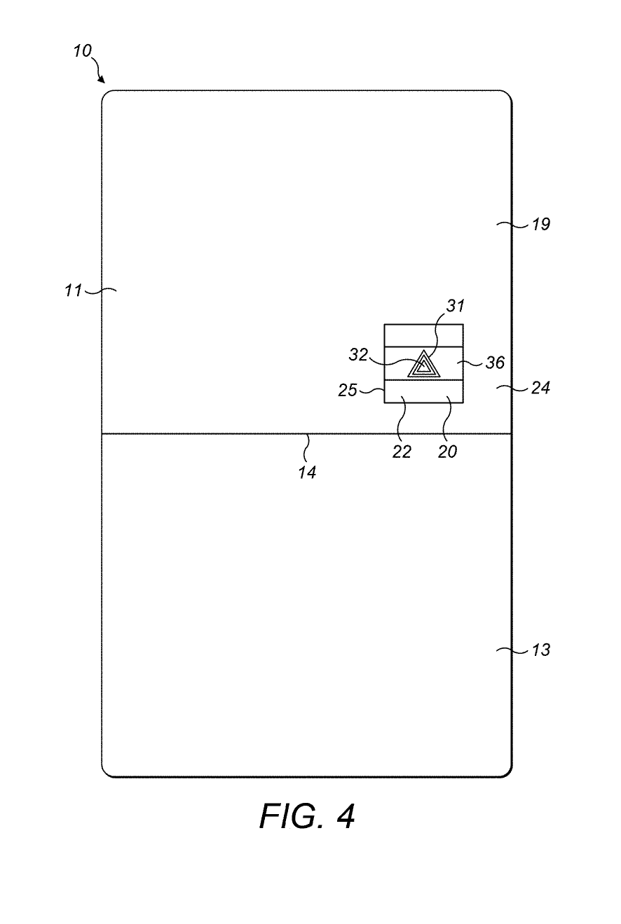

As illustrated in FIG. 4, the first outer surface 18 of the first polymer page 11 and the opposing surface 38 of the adjacent page 12 may be brought together about the fold line 14. The adjacent page 12 is visible through the at least one window 25 when viewed in reflected light incident upon the second outer surface 19 of the first polymer page 11. The reflected light may be visible or non-visible light. The first and second security devices 30, 35, and particularly the first and second elements 31, 32, are visible together in the at least one window 25 and are preferably registered to one another. In the illustrated embodiment the second element 32 is visible as a solid triangle within the hollow triangle of the first element 31 and the first and second elements 31, 32 are in register with one another. The first and second elements 31, 32 are in register with one another by virtue of their outer perimeter shapes being the same but of a different scale factor and by virtue of the second element 32 being located within the first element 31 when the second outer surface 19 is viewed in reflected light.

The security document 10 may be formed by virtue of attachment along the fold line 14 in any suitable form allowing the first polymer page 11 and adjacent page 12 to be attached to one another along edges and to rotate or pivot relative to one another about the fold line 14. For example, the security document 10 may comprise a line of stitching along the fold line 14, which may be constructed in a manner disclosed in WO-A-2011/151638. The security document 10 may comprises a plurality of leaves forming the first polymer page 11, adjacent page 12 and the visa pages and attached along the line of stitching. At least one stitching thread may pass through the fibrous substrate 17 forming the plurality of visa pages 16 and the first polymer substrate 20 forming the first polymer page 11. All or part of the outer visa page 16 and first polymer substrate 20 may be adhered to the cover 13 to form the booklet.

In order to reproduce such a security document 10 a counterfeiter needs to embed the first and second security devices 30, 35 in both the first polymer page 11 and adjacent page 12. As will become apparent from the following description, very different machinery may be required for forming the different materials and different first and second security devices 30, 35, thereby increasing the costs to the counterfeiter and the level of skill required. A counterfeiter would also need to ensure that the first and second security devices 30, 35 and at least one window 25 are accurately located relative to one another such that the first and second security devices 30, 35 are visible through the at least one window 25.

### B. Inclusion of a Second Polymer Page in the Security Document

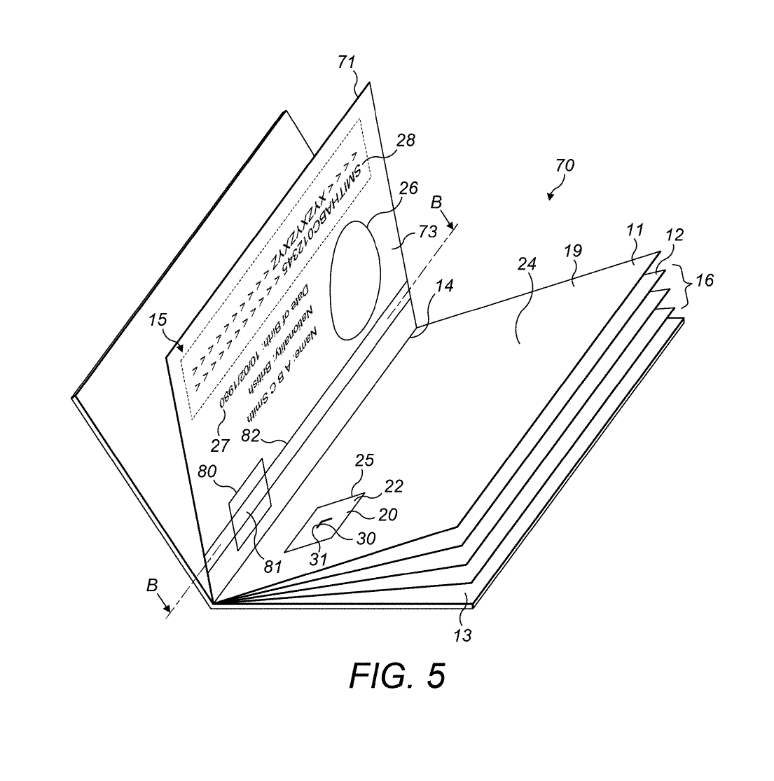

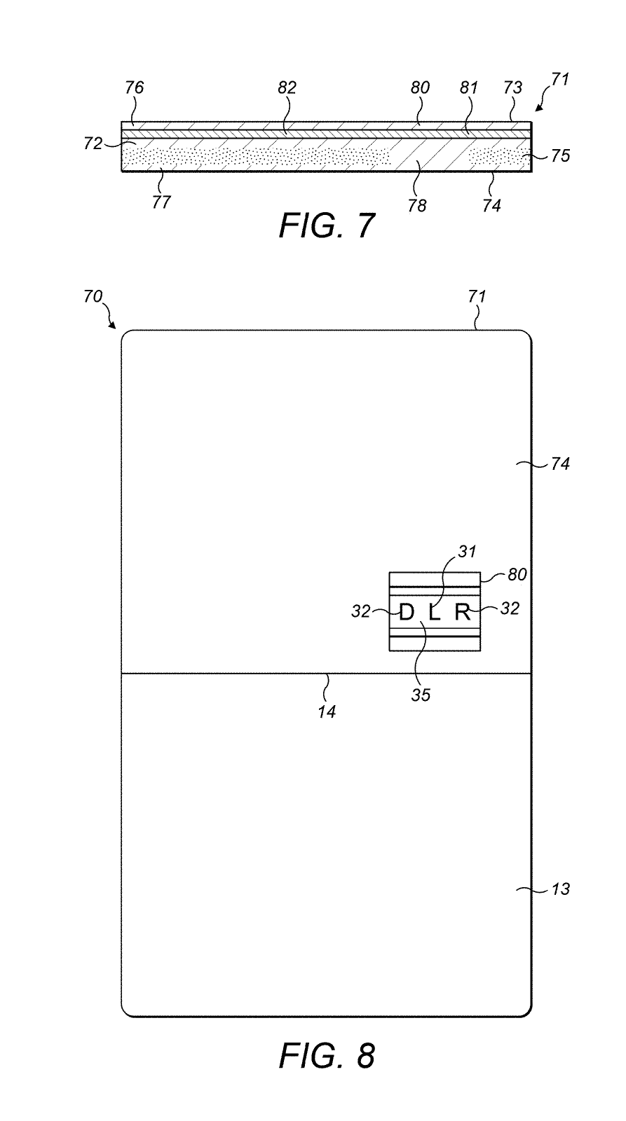

FIGS. 5 to 8 illustrate a further embodiment of the present invention in which a security document 70 comprises a second polymer page 71, preferably located between the first polymer page 11 and cover 13. FIGS. 5 to 8 contain, where appropriate, reference numerals corresponding to those used in FIGS. 1 to 4. Preferably, as illustrated, the second polymer page 71 is the data page and comprises the personal data 15.

The second polymer page 71 preferably has a different composition to that of the first polymer page 11. In particular, the compositions of the first and second polymer pages 11, 71 may differ in structure and/or materials. As a result, different techniques are required to create each of the first and second polymer pages 11, 71 and the difficulty of counterfeiting is increased. The different composition may result from differing materials, arrangements of opacifying layers, thicknesses, rigidities and abilities to contain security features. In a particularly preferred embodiment the first polymer page 11 comprises a first polymer substrate 20 formed from a single layer and at least one outer opacifying layer 23, 24 on its first and/or second substrate surface 21, 22 whilst the second polymer page 71 is formed from a plurality of plastic layers fused together.

The second polymer page 71 preferably comprises a substantially rigid second polymer substrate 72 or “plastic substrate” having a first outer surface 73 and a second outer surface 74. Each of the first and second outer surfaces 73, 74 is preferably substantially flat and planar. The second polymer substrate 72 is formed from a plurality of layers which are fused together into a substantially non-laminar or unitary structure. The second polymer substrate 72 preferably comprises a different synthetic polymer, which is preferably non-fibrous, to that of the first polymer substrate 20. The second polymer substrate 72 may be a thermoplastic polymer such as polycarbonate, polyester, polyethylene, polypropylene or polyvinyl chloride. Polycarbonate is particularly suitable due to its high durability, its ease of manufacture and the ease with which security features can be incorporated within it.

The second polymer page 71 is thicker than the first polymer page 11. The thickness of the second polymer substrate 72, which is the distance between the first and second outer surfaces 73, 74, is preferably at least approximately 150 μm and more preferably at least approximately 300 μm. In particular, the second polymer substrate 72 may be between approximately 300 μm and approximately 1000 μm thick, more preferably between approximately 600 μm and approximately 800 μm thick and, for example, may be approximately 300 μm or approximately 800 μm thick. The second polymer substrate 72 is substantially thicker and more rigid than the first polymer substrate 20. In a particular, the second polymer substrate 72 or second polymer page 71 is at least twice the thickness, and more preferably at least three times the thickness of the first polymer substrate 20 or the first polymer page 11. The adjacent page 12 is preferably thinner than the second polymer page 71 and thicker than the first polymer page 11.

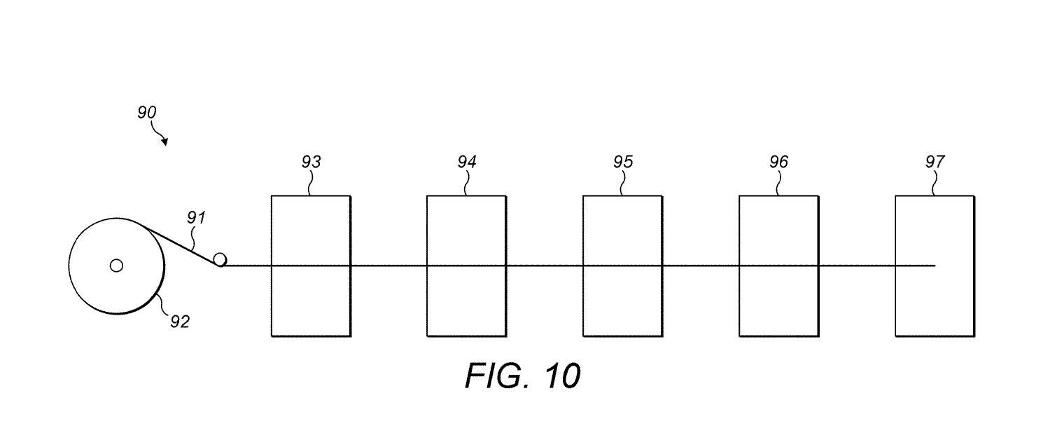

As illustrated in FIG. 10, the second polymer substrate 72 preferably comprises a substantially opaque region 75 within its thickness and separated from the first and second outer surfaces 73, 74 by first and second substantially transparent regions 76, 77. The opaque region 75 at least partially borders at least one third substantially transparent region 78. The first, second and third transparent regions 76, 77, 78 form at least one window 80 through the second polymer substrate 72. In the illustrated embodiment a single, square window 80 extends through the thickness of the second polymer substrate 72.

The personal data 15 may be formed by a series of laser markings or engravings within the second polymer substrate 72 in the first transparent region 76 between the opaque region 75 and the first outer surface 73. The laser markings are preferably visible when the first outer surface 73 is viewed in reflected light incident upon the first outer surface 73 by virtue of the first transparent region 76 in which they are located. The second polymer substrate 72 may also comprise any other suitable security feature, such as a hologram in the form of non-variable data, UV responsive features, optically variable features, windowed or transparent features, antenna, electronic chips and laser-perforations.

The second polymer page 71 may further comprise a third security device 81 disposed in or on the second polymer substrate 72 and at least partially in the at least one window 80 or, alternatively, outside of the at least one window 80. In the illustrated embodiment the third security device 81 comprises a security thread 82 located in the first transparent region 76 between the opaque region 75 and the first outer surface 73. The security thread 82 is preferably between approximately 1 mm and 20 mm wide. As a result, the security thread 82 is visible along its entire length across the second polymer page 71 when the first outer surface 73 is viewed in reflected light. When the second outer surface 74 of the second polymer page 71 is viewed in reflected light, only the portion of the security thread 82 in the at least one window 80 is visible as the opaque region 75 blocks the rest of the security thread 82 from view. In an alternative embodiment the security thread 82 is located in the second transparent region 77 such that it is visible along its entire length on the second outer surface 74 and only visible in the at least one window 80 on the first outer surface 73. In yet a further embodiment the second polymer substrate 72 comprises a plurality of windows 80 and the third security device 81 is located in each window 80 such that it is visible at a plurality of locations. Various other embodiments of the third security device 81 are discussed in further detail below.

The third security device 81 and at least one window 80 of the second polymer page 71 are arranged to interact with the first and/or second security devices 30, 35 to form at least one security feature which is different to the independent security features or effects of each of the first, second and third security devices 30, 35, 81. In particular, the at least one window 80 of the second polymer page 71 and at least one window 25 of the first polymer page 11 are arranged to overlie one another when the first and second polymer pages 11, 71 are brought together about the fold line 14 such that the first outer surface 73 of the second polymer page 71 is adjacent to the second outer surface 19 of the first polymer page 11. The second security device 35 is also visible through the windows 25, 80 if the opposing surface 38 of the adjacent page 12 is also brought about the fold line 14 to be adjacent to the first outer surface 18 of the first polymer page 11.

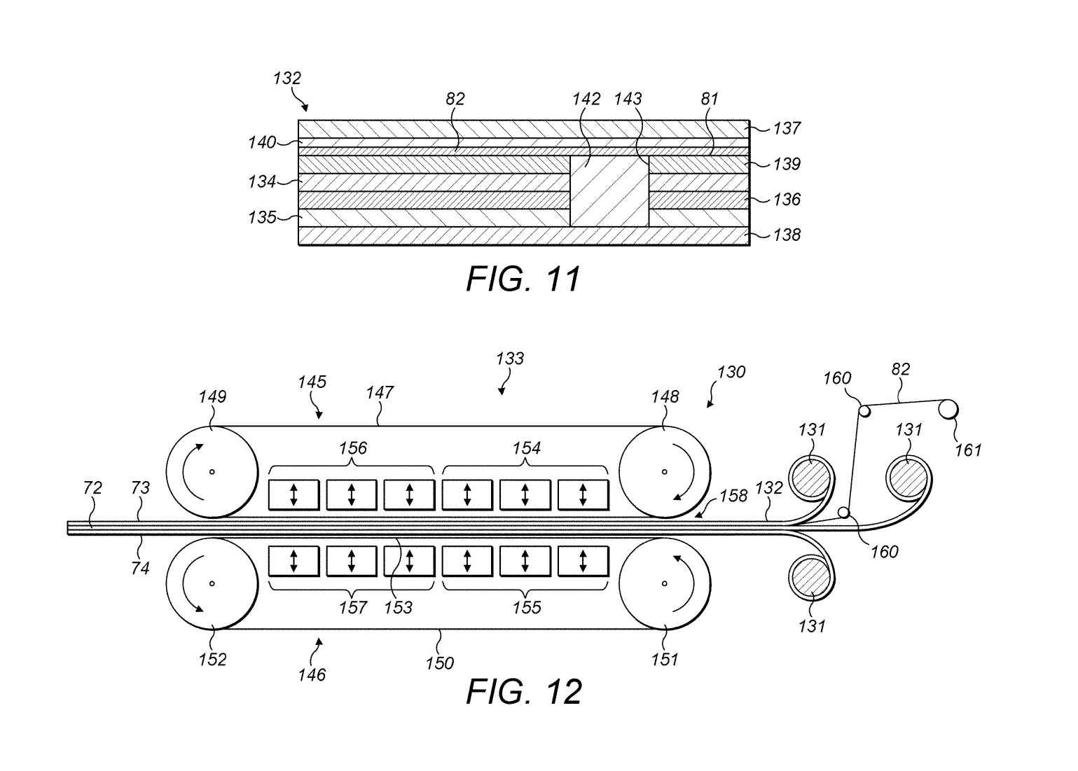

In the embodiment of FIGS. 8 to 11 a plurality of second elements 32 form a first pattern of the letters “D” and “R” and a first element 31 forms a second pattern of an “L” located in the window 25. The first and second elements 31, 32 comprise printed ink. When viewed in reflected light through the window 25 the first and second elements 31, 32 combine to form a third pattern, in this case “DLR” (see FIG. 11), which is different from the first and second patterns. The third security device 81 comprises a substantially transparent security thread 82 comprising an optical filter or lens and arranged to adjust the observed image of the first and second security devices 30, 35 when viewed through the third security device 81 in reflected light.

In order to reproduce this security document 70 a counterfeiter needs to also embed the third security device 81 within the second polymer substrate 72. Again, as will become apparent from the following description, very different machinery is required for forming the second polymer page 71 to that required for forming the first polymer page 11 and adjacent page 12, thereby increasing the costs to the counterfeiter and the level of skill required. Further difficulty is added by virtue of a counterfeiter needing to align the first, second and third security devices 30, 35, 81 and windows 25, 80. In addition, the combination of different materials enables a variety of different security features and effects to be achieved by unique combinations of the first, second and third security devices 30, 35, 81.

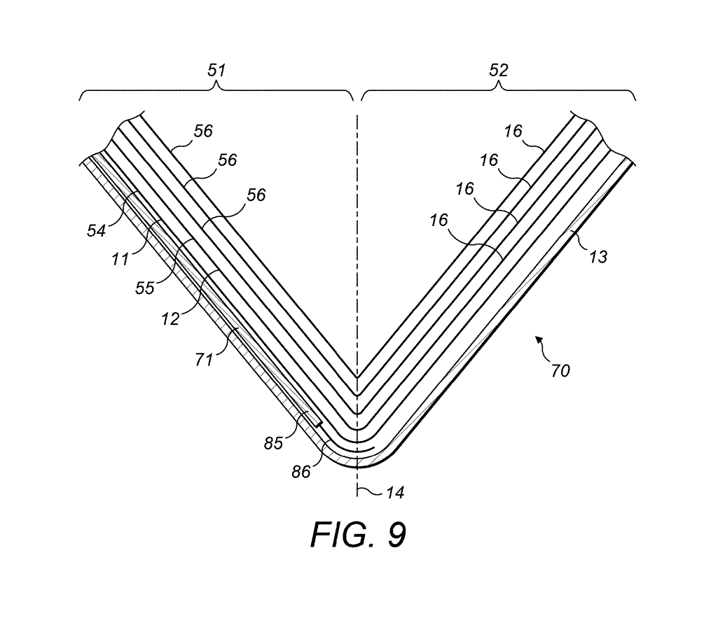

As shown in FIG. 9, the security document 70 comprises a first side 51 and a second side 52 on either side of the fold line 14 about which the first and second sides 51, 52 can be rotated and brought together. The security document 70 comprises a first leaf 54, which comprises the first polymer page 11 at the first side 51, and a second leaf 55 inwards of the first leaf 54, which comprises the adjacent page 12 on the first side 51 and a visa page 16 on the second side 52. Further leaves 56 are located inwards of the second leaf 55 and form further visa pages 16 on the first and second sides 51, 52. A third leaf 85 comprises the second polymer page 71 and a connection tab 86 extending from the second polymer page 71 and is located between the first leaf 54 and the cover 13. FIG. 12 illustrates the leaves 54, 55, 56, 85 and cover 13 in an exploded configuration and in the constructed security document 70 they may be stitched together along a stich line along the fold line 14.

The connection tab 86 may comprise the same plastic as that forming the second polymer substrate 72 of the second polymer page 71 and may be formed by one of the plurality of layers forming the second polymer page 71 extending beyond its inner edge (i.e. the edge adjacent to the fold line 14). Alternatively, the connection tab 86 may comprise a fabric (such as a woven mesh) or different material integrated with the second polymer page 71 during manufacture. The connection tab 86 may then be adhered to the first leaf 54 or may not be directly connected to the first leaf 54 other than by the fold line 14. EP-B-1592565 discloses a particularly suitable method of forming a connection tab 86 of a flexible and bending resistant material, such as overlying layers of PE and PET.

### C. Method of Manufacture

The first polymer page 11, adjacent page 12, plurality of visa pages 16, cover 13 and, if present, second polymer page 71 are generally formed separately before being attached together along the fold line 14 to form the security document 70. The personal data 15 is preferably applied after the rest of the security document 10, 70 has been assembled to complete the data page.

### C.1. Manufacture of the First Polymer Page

The first polymer page 11 may be manufactured by creating a web of first polymer substrate 20, applying the at least one opacifying layer 23, 24 to the first polymer substrate 20, adding the at least one first security device 30 to the at least one opacifying layer 23, 24 and/or first polymer substrate 20, splitting the web into a plurality of first leaves 54. A schematic of suitable apparatus 90 for forming the first polymer page 11 is illustrated in FIG. 10.

Initially, a polymer may be extruded or the like in the form of a substantially continuous film or web 91, which may, for example, have a width of between 0.75 m and 1.5 m and a length of many tens or hundreds of metres. The web 91 is subsequently rolled into a roll 92 which may be located at the end of the apparatus 90, which may be a substantially continuous processing line. The web 91 forms the first polymer substrate 20 and its first and second substrate surfaces 21, 22.

The web 91 may be conveyed from the roll 92 and undergo one or more treatment steps in a treatment area 93. For example, an intermediate layer or the like may be applied to the first and second substrate surfaces 21, 22 by one or more rollers, brushes or the like. Alternatively the web 91 may undergo plasma or corona treatment. Such treatment steps may also be applied to the web 91 before it is rolled into the roll 92.

At an opacifying layer station 94 the at least one opacifying layer 23, 24 may be applied to the first and/or second substrate surface 21, 22. The opacifying layer station 94 may build up the at least one opacifying layer 23, 24 by sequentially applying thinner layers of material, which are typically polymeric materials as discussed above. The optical density of each thinner layer may typically be around 0.2 to 0.5 and preferably three or more layers are applied to form each of the each opacifying layer 23, 24. The at least one opacifying layer 23, 24 may be omitted in certain regions to form the at least one full or half window 25. The at least one opacifying layer 23, 24 may be printed, coated or otherwise applied to the web 91. Preferably it is applied using a printing process such as gravure, offset, flexographic, lithographic or the like.

In an alternative embodiment, each opacifying layer 23, 24 may comprise a self-supporting pre-formed layer, including apertures for forming the at least one window 25, which is laminated to the first polymer substrate 20. In particular, the at least one opacifying layer 23, 24 may comprise a polymer or fibrous substrate, such as paper, to form a first polymer page 11 having a “hybrid” paper and polymer construction.

At a graphics station 95 the graphics may be applied to the at least one opacifying layer 23, 24 and/or first polymer substrate 20. For example, the graphics may be printed by any conventional printing technique, or combination of techniques, such as intaglio printing, lithographic printing, offset printing, flexographic printing, gravure printing and the like.

At a security device station 96 the at least one first security device 30 may be applied to the web 91. In particular, the at least one first element 31 may be printed thereon by any of the aforementioned printing techniques. Alternatively, the at least one first element 31 may be marked in the at least one window 25 by a laser or the like. The security device station 96 may be located upstream of the graphics station 95 such that the at least one first security device 30 is applied before the graphics. Various other embodiments of the at least one first security device 30 are discussed in further detail below.

At a cutting station 97 the web 91 is subsequently cut into a plurality sheets, each forming a first leaf 54. The cutting station 97 may alternatively be located upstream of the graphics station 95 and/or security device station 96 such that the graphics and/or at least one first security device 30 are applied to individual first leaves 54.

### C.2. Manufacture of the Adjacent Page and the Visa Pages

The adjacent page 12 is preferably produced in a similar manner to the method disclosed in EP-A-0059056 or WO-A-2005/069231, the contents of which are incorporated herein by reference, in order to incorporate the second security device 35 in the form of the security thread 36 into the fibrous substrate 17. A cylinder mould papermaking machine comprises a cylinder mould rotating in a vat of aqueous fibrous stock. The fibrous stock may comprise a range of fibre types, including synthetic or natural fibres, or a mixture of both. A cellulose, wood and/or cotton based mixture is particularly preferable. The fibrous substrate 17 may be of any grammage, but a grammage of at least 110 gsm is preferred. As the cylinder mould rotates, the liquid within the fibrous stock passes through the porous support surface of a cylinder mould cover. The fibres are deposited on the support surface and the layer of fibrous substrate 17 is thereby formed.

The cylinder mould cover may comprise a plurality of raised regions, which may, for example, be embossed regions as in EP-A-0059056 or drainage restriction regions as in WO-A-2005/069231. The security thread 36 is brought into contact with each raised region so that the security thread 36 is lying over the raised region as fibres begin to deposit on the cylinder mould cover. Fibres are deposited above and below the security thread 36, but substantially none are deposited where the security thread 36 contacts the raised regions, thereby forming the at least one exposed region 37. The bridges 39 are formed by the deposition of fibres between adjacent raised regions on the cylinder mould cover 183.

Water is extracted from the wet fibrous web and the web of paper undergoes a drying process. The dried web is initially cut along cutting lines to form a plurality of interim sheets and these interim sheets are typically printed upon and cut into individual smaller sheets, each of which may form a second leaf 55.

The plurality of visa pages 16 are generally formed in a similar manner to the adjacent page 12, except without the addition of the security thread 36, as is well known in the art. The plurality of visa pages 16 may have a lower grammage than that of the adjacent page 12, for example approximately 85 gsm.

### C.3. Manufacture of the Second Polymer Page

The second polymer page is generally manufactured by forming an insert 142, forming a plurality of plastic layers 132 (shown in FIG. 11) including the insert 142 and third security device 81 therein and laminating the plurality of plastic layers 132 together in a laminator 133 (shown in FIG. 12) to form the second polymer substrate 72.

FIG. 11 illustrates a suitable structure for the plurality of plastic layers 132 prior to entering the laminator 133 and after being positioned to overlie one another. The plurality of plastic layers 132 is preferably capable of forming a plurality of third leaves 85, although only a portion of the plurality of plastic layers 132 for forming a second polymer page 71 is shown. In particular, the plurality of plastic layers 132 comprises first and second opaque layers 134, 135, which are typically white and/or opaque, and an inlay 136 therebetween. Graphical information, colours and/or patterns may be printed on the outer surfaces of the first and second opaque layers 134, 135. Electronic chips and antenna or the like may be located within the inlay 136 or first and second opaque layers 134, 135.

Substantially transparent first and second overlays 137, 138 are located at the outer most sides of the plurality of plastic layers 132 and form the first and second outer surfaces 73, 74 of the second polymer substrate 72. First and second intermediate layers 139, 140 for holding security features may be located between the first opaque layer 134 and the first overlay 137. In particular, the first intermediate layer 139 may be substantially opaque and located adjacent to the first opaque layer 134. The second intermediate layer 140 is located between the first overlay 137 and the first intermediate layer 139 and is substantially transparent. In other embodiments any suitable number of intermediate layers, on either side of the first and second opaque layers 134, 135, may be used in order to provide different security features.

The connection tab 86 may be formed by any means known as the art, for example as described in EP-B-1592565. One or more of the plurality of plastic layers 132 may be wider than the rest of the plurality if plastic layers 132 such that it extends from the formed second polymer substrate 72 and forms the connection tab 86.

A strip of substantially transparent plastic may initially be cut by a punching tool to form a plurality of inserts 142 before or during the arrangement of the plurality of plastic layers 132. The shape of the perimeter of each insert 142 forms the shape of the perimeter of each window 80. Each insert 142 is located in an aperture 143 through the first and second opaque layers 134, 135, the inlay 136 and the first intermediate layer 139. The opposing outer surfaces of each insert 142 are overlaid by the second overlay 138 and second intermediate layer 140. Alternatively, each aperture 143 may be formed in, and each insert 142 located in, only one or two of the first opaque layer 134, the second opaque layer 135, the inlay 136 and/or the first intermediate layer 139. Preferably the aperture 143 and insert 142 are formed and brought together in line, as is disclosed in WO-A-2015/104011. In particular, a single punch tool may be operated to form an aperture 143, cut or punch an insert 142 from the strip and place the insert 142 into the correspondingly shaped aperture 143.

Each of the plurality of plastic layers 132 may be between approximately 0.05 mm thick and approximately 3 mm thick and is comprised of the plastic forming the second polymer substrate 72, such as polycarbonate, although they may be formed of different plastics provided that they are able to fuse together. Each insert 142 may have a thickness of between approximately 0.1 mm and approximately 0.4 mm and may be the same plastic from which the plurality of plastic layers 132 are formed, such as polycarbonate or the like.

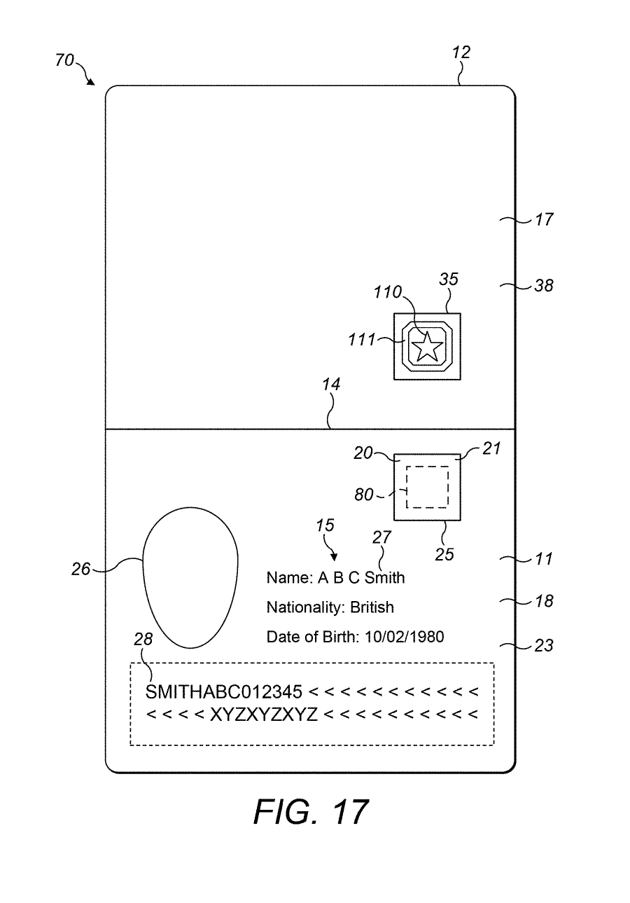

As illustrated in FIG. 17 the third security device 81, in this case the security thread 82, may be located between the first and second intermediate layers 139, 140. Alternatively, as discussed below, one of the first and second intermediate layers 139, 140 may comprise the third security device 81 embedded in it. The third security device 81 may be located at the first or second outer surface 73, 74 of the second polymer substrate 72, for example by being adhered thereto, or it may be at least partially embedded within the second polymer substrate 72, for example by being fused therewith. In particular, prior to lamination the third security device 81 may be located on or within the insert 142. Alternatively, the third security device 81 may be located on the first overlay 137, second overlay 138 or second intermediate layer 140 and at least partially overlie the insert 142.

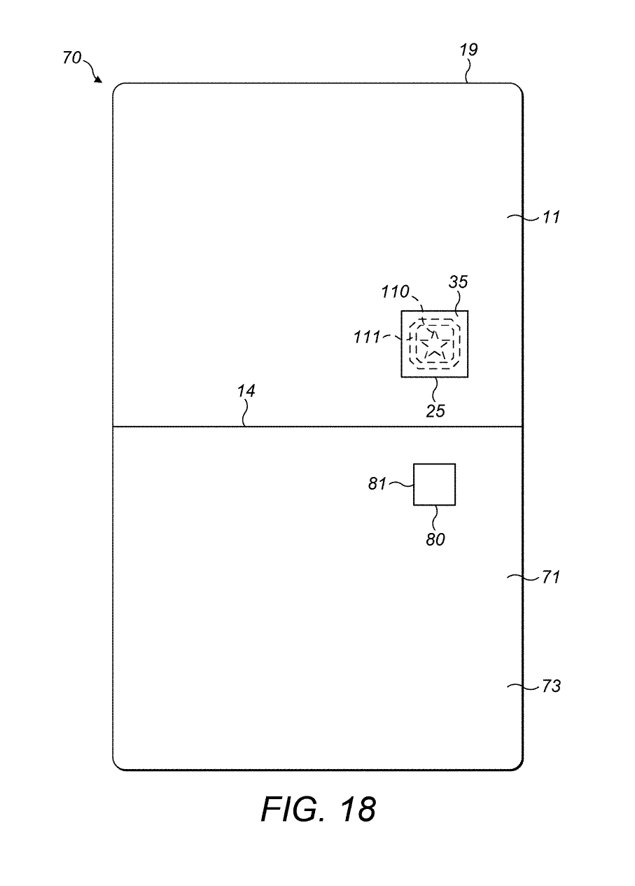

FIG. 18 illustrates an embodiment of an apparatus 130 suitable for manufacturing the third leaf 85 from the plurality of plastic layers 132. The apparatus 130 is similar to the devices disclosed in U.S. Pat. No. 6,669,813 and US-A-2011/0226408, the contents of which are incorporated herein by reference. The apparatus 130 comprises a plurality of feeders 131 for feeding the plurality of plastic layers 132 laid over one another into the laminator 133. The laminator 133 fuses the plurality of plastic layers 132 together by the application of heat and pressure to form the second polymer substrate 72.

The laminator 133 comprises first and second continuous belts 145, 146 which rotate in opposite directions and comprise first and second support surfaces 147 150 respectively. At least one of the first and second continuous belts 145, 146 is intermittently driven to draw the plurality of plastic layers 132 into a laminating region 153 of the laminator 133 through a nip 158 between first and second inlet drums 148, 151. Initially a region of the plurality of plastic layers 132 is moved into between opposing heating devices 154, 155. The heating devices 154, 155 move towards the first and second support surfaces 147, 150 to heat and apply pressure to the region of plurality of plastic layers 132 to form the second polymer substrate 172. After a set period of time, typically less than a minute, the heating devices 154, 155 move away from the first and second support surfaces 147, 150 and the first and/or second continuous belt 145, 146 is driven to move the region to between opposing cooling devices 156, 157. The cooling devices 156, 157 move towards the first and second support surfaces 147, 150 and cool and apply pressure to the second polymer substrate 72 in order to maintain its structure. This heating, cooling and pressure application process is repeated along the plurality of alternating heating and cooling devices 154, 155, 156, 157 until the fully formed second polymer substrate 72 exits the laminator 133.

The third security device 81 may be incorporated into the plurality of plastic layers 132 either before or during entry into the laminator 133. For example, the third security device 81 may be positioned and/or adhered on one of the plurality of plastic layers 132 or the insert 142. Alternatively, as illustrated, the third security device 81 may be fed into the plurality of plastic layers 132 at the nip 158 by being introduced into the second polymer substrate 72 by being fed in between two of the plurality of plastic layers 132 from a bobbin 159 via at least one roller 160.

During the heating process each of the plurality of plastic layers 132 and insert 142 become at least softened or semi-molten (i.e. a liquid of relatively high viscosity) so that the plastic flows and mixes together across the interfaces between them. The first overlay 137 and second intermediate layer 140 form the first transparent region 76. The first and second opaque layers 134, 135, the inlay 136 and the first intermediate layer 139 form the opaque region 75. The second overlay 138 forms the second transparent region 77. The insert 42 forms the third transparent regions 78 and window 80.

In order to achieve such fusing the heating devices 154, 155 may be suitably controlled to raise the temperature and pressure applied to the plurality of plastic layers 132 to reach the softening point of the plastic. A temperature at which deformation and therefore fusion is possible at a certain pressure can be ascertained using the Vicat softening point test of any of the methods of the ASTM D 1525 and ISO 306 standards. In a particular example, the Vicat softening point for polycarbonate can be determined using a heating rate of 50° C./hr and a load of 50 N. In an example for polycarbonate, the heating devices 154, 155 may apply a temperature of approximately 180° C. at approximately 8 MPa to the plurality of plastic layers 132 and the cooling devices 156, 157 may apply a temperature of approximately 20° C. to 30° C. and a pressure of 10 MPa to the plurality of plastic layers 132.

After the second polymer substrate 72 has exited the laminator 133 it may be subjected to further processing, such as the addition of further security features to the first and second outer surfaces 73, 74. If located on the first or second outer surface 73, 74, the third security device 81 may be applied thereto. The second polymer substrate 72 is also cut into a plurality of third leaves 85.

### C.4. Assembly of the Security Document

The first leaf 54, second leaf 55, third leaf 85, further leaves 56 and/or cover 13 are bound along the fold line 14, for example by stitching, with the cover 13 to form the security document 10, 70. Suitable stitching processes include those discussed WO-A-2011/151638, the contents of which are incorporated herein by reference.

The personal data 15 relating to the holder of the security document 10, 70 is preferably applied after the binding step. However, it is possible to apply the personal data 15 before the binding and during any stage of the aforementioned manufacturing processes.

### D. The Security Devices

The first, second and third security devices 30, 35, 81 are features that create an effect which is difficult to reproduce. Preferably they cannot be reproduced accurately by taking a visible light copy using, for example, a commonly and commercially available photocopier, scanner or printer. Preferably the first, second and third security devices 30, 35, 81 are different from one another such that a counterfeiter must utilise at least two different manufacturing processes to form them.

The first, second and third security devices 30, 35, 81 may each comprise at least one first, second and third element 31, 32, 33 respectively mounted on a carrier substrate. The security effects may be derivable from the composition of the first, second and third security devices 30, 35, 81, the shapes of the perimeters of the first, second and third elements 31, 32, 33 and/or the shapes of the perimeters of the carrier substrates of the first, second and/or third security devices 30, 35, 81. In particular, the perimeters may form any suitable shape, such as a recognisable pattern, indicium (i.e. signs, indications or distinguishing marks), alphanumeric character, symbol, logo, graphic or the like. They may form overt readable information which is observable in visible light or, alternatively, covert readable information which is observable in non-visible (such as UV) light or which contains a code. Furthermore, the first, second and/or third elements 31, 32, 33 may have perimeters of the same shape. The first, second and/or third security devices 30, 35, 81 are located such that they are visible together through the at least one window 25, 80 such that their similarity can be checked. In a particular embodiment the first, second and/or third security devices 30, 35, 81 comprise indicia in the form of a serial number of the security document 10, 70.

The security of the security document 10, 70 can be further improved by forming distinguishable patterns or the like using combinations of the first, second and third security devices 30, 35, 81 and first, second and third elements 31, 32, 33. Preferably the patterns form readable information, including indicium and/or alphanumeric characters. The personal data 15 may be at least partially formed by the first, second and/or third elements 31, 32, 33.

Preferably the first, second and/or third security devices 30, 35, 81 are in register such that a user or official can easily detect a counterfeit document if the first, second and/or third security devices 30, 35, 81 are out of register. The term “in register” may be defined in the present disclosure as meaning that the first, second and/or third security devices 30, 35, 81 are at the same predetermined position in a plurality of security documents 10, 70. In particular:

They may be registered to other features of the security document 10, 70. For example, they may be at the same predetermined relative position to the outer edges of the first polymer page 11, the adjacent page 12 or the second polymer page 71 and/or to the edges of the at least one windows 25, 80.

They may be registered to each other such that they are at the same predetermined relative position in a plurality of security documents 10, 70. In a particular embodiment at least one first, second and/or third elements 31, 32, 33 are in register with a window 25, 80 of the first or second polymer page 11, 71 on which the at least one first, second and/or third elements 31, 32, 33 is not located.

They may be registered to each other such that they combine or co-operate to form a visible security effect when viewed together, preferably in reflected visible light, which is not visible when they are each viewed alone.

The at least one first security device 30 may comprise a security feature suitable for incorporation into or onto the first polymer substrate 20 and/or at least one opacifying layer 23, 24. The at least one second security device 35 comprises a security feature suitable for incorporation into the fibrous substrate 17 and which is at least partially exposed on the opposing surface 38 of the adjacent page 12. The at least one third security device 81 may comprise a security feature suitable for incorporation into the second polymer substrate 72 and which is preferably visible through the at least one window 80.

In particular, the at least one first, second and/or third security device 30, 35, 81, and particularly the at least one first, second and/or third security elements 31, 33 and/or carrier substrates, may comprise at least one of:

Printed ink, laser markings, UV responsive features, optically variable features, windowed or transparent features, demetallised features, laser perforations, microtext, fine line patterns, latent images, venetian blind devices and the like;

Optical filters, diffractive structures including diffraction gratings and holographic structures, reflective facets including prismatic or pyramidal structures;

Threads, strips, patches, holograms, foils, hot foils and the like upon which the first, second and/or third security elements 31, 33 may be located;

In the case of the second security device watermarks, electrotype watermarks, security fibres,

Microlenses, micromirrors, lenticular devices, moiré interference devices, moiré magnification devices, lenses, mirrors, other focusing elements and the like, having a focusing array and an image array. The first, second and/or third security device 30, 35, 81 may comprise both of, or just one of, the focusing array and image array;

Antenna, electronic chips and the like;

Covert printed ink comprising an optically detectable material. The printed ink may be transparent such that it is not observable in visible light, but may be observed by the human eye and/or a machine via an optical detector such as a camera. The optical detection characteristic(s) of the material could include, for example, non-visible reflection or absorbance (such as UV or IR reflection or absorbance), a photoluminescent response such as fluorescence or phosphorescence (the stimulating radiation and/or the emitted radiation being unobservable in visible light), or the like. Alternatively, the printed ink may be observable in visible light but also capable of exhibiting such characteristics when exposed to non-visible light.

Printed ink having optically variable properties, such as iridescence or the aforementioned iridescent amplitude interference materials, in which the appearance of the ink is different at different viewing angles. In particular, the ink may exhibit colour shifting effects which are only substantially visible when the ink is viewed in reflected light against an opaque background. Suitable inks are disclosed in GB-A-2441261, the contents of which are incorporated herein by reference.

One or more windows 25, 80, in which the carrier substrate comprises is substantially transparent. For example, in the case of the second polymer page 71, the carrier substrate may comprise a thermoplastic polymer such as polycarbonate to enable it to fuse with the plurality of plastic layers 132;

Iridescent amplitude interference materials, which display different colours at different viewing angles. Examples include thin-film interference structures, interference pigments, pearlescent pigments, liquid crystal film and pigments, photonic crystals and the like. Thin film interference structures comprise repeating layers of different refractive indices; examples can include purely dielectric stacks (metal oxide or polymer) or those composed of alternate dielectric and metallic layers. Thin film interference structures are also known as Bragg stacks, as disclosed in WO-A-2015113143, or photonic crystal tunable materials, as disclosed in EP-A-2714411, or one dimensional photonic crystals. Such iridescent amplitude interference materials comprise two or more closely spaced interfaces, at least one of which partially reflects and partially transmits incident light such that the amplitude of the incident light is split. The transmitted portion is reflected at the second or subsequent interface(s) and interferes with the portion reflected from the first or earlier interface(s), leading to constructive interference of some wavelengths and destructive interference of others. As a result, the materials exhibit a characteristic colour which varies with viewing angle.

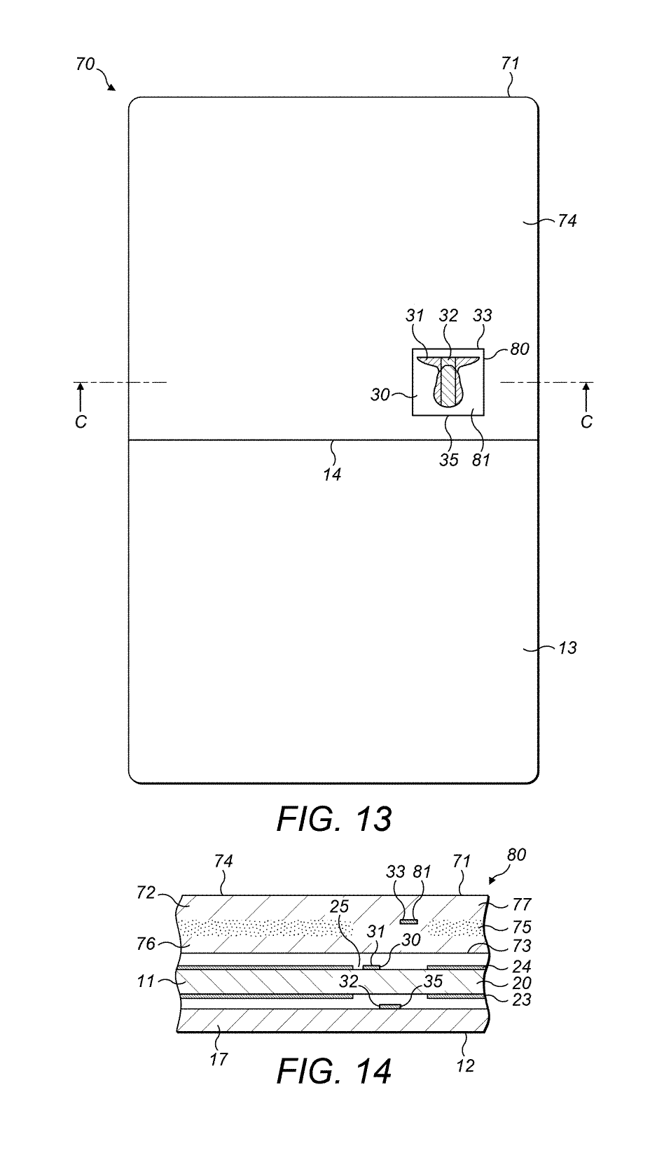

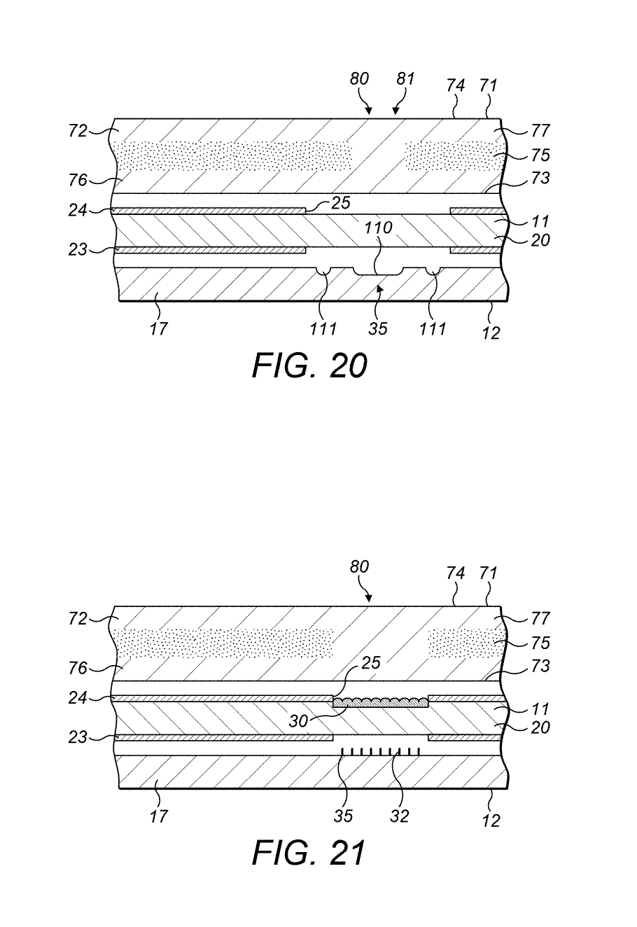

Particular embodiments of the at least one first, second and/or third security device 30, 35, 81, will now be described, particularly with reference to FIGS. 13 to 23.

In an embodiment the third security device 81 comprises printed ink forming an opaque stripe on the first intermediate layer 139 which extends between edges of the second polymer page 71 such that it is laid out in a similar manner to the security thread 82 as shown in FIG. 8. As such, it may be difficult for a naked eye to distinguish it from a true security thread, such as the security thread 82.

The first, second and/or third security devices 30, 35, 81 may each comprise patterns in the form of fine line arrays which, when laid over each other, form moiré images. Such fine line arrays may be formed from printed ink or laser markings and may be located on a carrier substrate, such as in a security thread, patch or the like. Registration marks or the like may be provided to enable a user to align the fine line arrays.

The first and/or third security devices 30, 81 may comprise optical filters arranged to adjust the observed image of any of the other first, second and/or third security devices 30, 35, 81. As in the embodiment of FIGS. 5 to 8, the first and third security devices 30, 35, 81 may comprise a transparent carrier substrate, such as a security thread, patch or the like forming the filter. Alternatively the filter may be formed by the first or second polymer substrate 20, 72, for example by being incorporated into the insert 142 or web 91 during manufacture. The filter may, for example, be metameric or polarising. In a particular embodiment the second security device 35 comprises at least one second element 32 comprising a metameric ink, which changes colour depending upon the lighting conditions. The first and/or third security devices 30, 81 comprises a metameric filter which can overlie the at least one second element 32 to create an altered wavelength environment and thereby reveal the colour changing properties of the metameric ink. Such an arrangement is similar to that disclosed in EP-A-0930979. Alternatively, the first and/or third security devices 30, 81 may each comprise a polarising filter having polarising directions that are orthogonal to one another when overlaid. As a result, when overlaid, the transparent filters would become a dark region. Alternatively, the first and/or third security devices 30, 81 may comprise a patterned polarisation coating or the like which, when overlaid, reveal a dark pattern or image.

In one embodiment the first security device 30 comprises a semi-transparent colour shifting ink located on the first polymer substrate 20 in the at least one window 25 which exhibits a colour shifting effect when viewed against the fibrous substrate 17 of the adjacent page 12 or, if present, against the opaque region 75 of the second polymer page 71. Alternative, the third security device 81 may comprise a colour shifting ink located within the at least one window 80 of the second polymer substrate 72 (for example by being present on the insert 142 during manufacture). The colour shifting effects may be visible when the third security device 81 is viewed in the at least one window 80 in reflected light against an opaque background formed by a half window 25 of the first polymer page 11. Alternatively, the opaque background could be formed by the fibrous substrate 17 being visible behind the colour shifting ink through a full window 25 of the first polymer page 11.

A plurality of windows 25 of the first polymer page 11 may comprise first security devices 30 in the form of different optically variable effect generating relief structures as disclosed in WO-A-2014184560, the contents of which are incorporated herein by reference. The relief structures may be formed by embossing, applying a curable material to or applying a layer defining a diffractive device to the first polymer substrate 20 or the like. The relief structures may differ in the information they convey, their sizes, their colours, by having different optically variable effect generating mechanisms or the like.

FIGS. 13 and 14 illustrate an embodiment in which the first, second and third elements 31, 32, 33 each form part of a complete image, which in this case is part of the portrait 26 of the personal data 15. When viewed adjacent to one another through the windows 25, 80 they align with one another to form the complete image or portrait 26. The first and second elements 31, 32 comprise printed ink on the first polymer page 11 and adjacent page 12. The third element 33 comprises a laser marking within the second polymer substrate 72 of the second polymer page 71, although it could comprise an ink on the first and/or second outer surface 73, 74.

In other embodiments the first, second and/or third security devices 30, 35, 81 may be identical or may comprise some identical first, second and third elements 31, 32, 33 and some non-identical first, second and third elements 31, 32, 33. In particular, they may each comprise an identical security thread 36, 82, patch or foil which can be viewed adjacent to one another in the windows 25, 80. As a result, the authenticity of the security document 10, 70 can be checked by ensuring that the security threads 36, 82, patches or foils are identical, which may not be the case if one or more of them has been replaced by a counterfeiter.

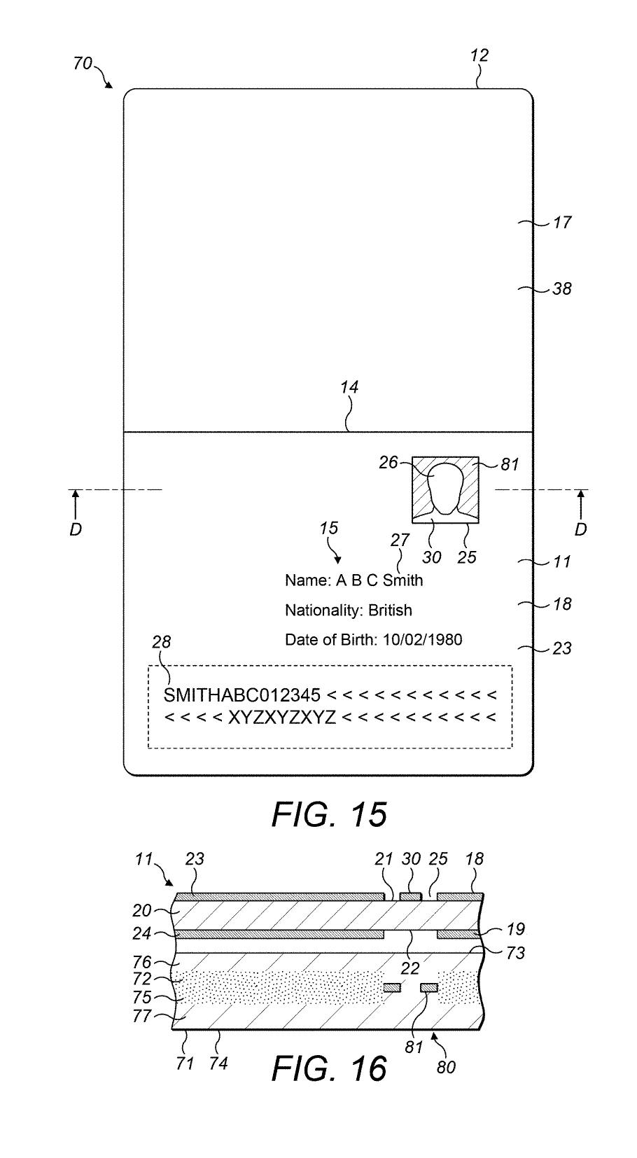

FIGS. 15 and 16 illustrate an embodiment in which the first, second and/or third security device 30. 35, 81 is used as a mask in the formation of at least one other of the first, second and/or third security device 30, 35, 81. In the illustrated embodiment the first security device 30 comprises printed ink, in the shape of the holder's portrait 26, located in the window 25 on the first substrate surface 21 of the first polymer substrate 20. The third security device 81 comprises markings within the second polymer substrate 72 around, but not overlying, the first security device 30 when the first and second polymer pages 11, 71 are adjacent to one another and the first polymer page 11 is viewed in reflected light. The markings may form a background around the portrait 26 and may be a dark background or an array of dots, fine lines or other such pattern.

During manufacture the printed ink is applied first to the first polymer substrate 20. Subsequently the second polymer page 71, which comprises a markable additive at least within the window 80, is positioned adjacent to the second outer surface 19 of the first polymer page 11. Laser light is directed through the window 25 of the first polymer page 11 to mark the second polymer page 71 around the first security device 30. The printed ink of the first security device 30 is sufficiently opaque that the laser light cannot pass through it and it acts as a mask to prevent the laser light reaching the second polymer page 71. As a result, the edge(s) of the markings forming the third security device 81 are perfectly in register with and adjacent to the edge(s) of the printed ink of the first security device 30.

In further embodiments the printed ink may be used as a mask in the marking of the adjacent page 12. Alternatively, the printed ink or the like may be located in the second polymer page 71 such that the laser markings can be formed in the first polymer page 11 and adjacent page 12.

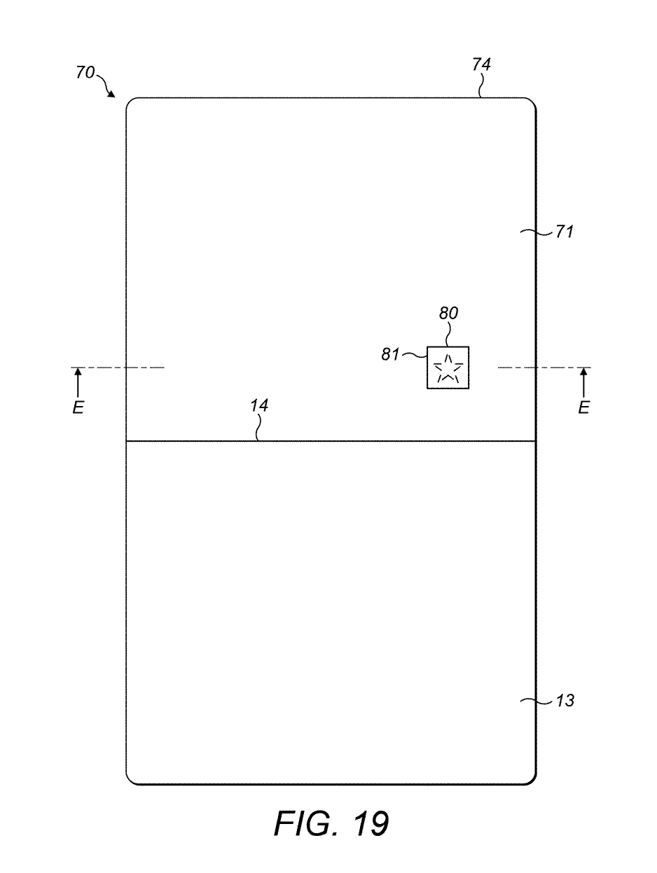

FIGS. 17 to 20 illustrate an embodiment in which the first security device 30 comprises the at least one window 25 of the first polymer page 11 and the third security device 81 comprises the at least one window 80 of the second polymer page 71. The edges of one of the at least one windows 25, 80 may be visible within the edges of the other at least one windows 25, 80. The windows 25, 80 of each of the first and second polymer pages 11, 71 overlie one another, but are of different sizes as the window 25 of the first polymer page 11 is smaller than the window 80 of the second polymer page 71. The windows 25, 80 can be used to partially hide parts of the second security device 35 of the adjacent page 12. In particular, the second security device 35 comprises an inner region 110 at least partially surrounded by an outer region 111, in this case in the form of a watermark. Preferably the inner region 110 forms a complete image, such as a pattern, indicia, symbol, logo or the like, which is independently distinguishable from the outer region 111. The entire watermark is visible when the security document 70 is opened between the adjacent page 12 and the first polymer page 11 (FIG. 17) and is also visible through the window 25 of the first polymer page 11 when the security document 70 is opened between the first and second polymer pages 11, 71 (FIG. 18). However, when the security document 70 is opened between the second polymer page 71 and cover 13 (FIG. 19), only the inner region 110 is visible through the window 80 of the second polymer page 71 as the opaque region 75 blocks out the outer region 111. A user or document inspector can therefore verify the correction positioning of the first, second and third security devices 30, 35, 81. In alternative embodiments the window 25 of the first polymer page 11 is larger than the window 80 of the second polymer page 71 and the second polymer page 71 is adjacent to the adjacent page 12.

FIGS. 21 to 23 illustrate further embodiments in which the first or third security devices 30, 81 comprise at least one focusing element arranged to form an image of a pattern formed by another of the first, second and/or third security devices 30, 35, 81 when observed through or via the at least one focusing element. In particular, the first or third security device 30, 81 may comprise a focusing element array located on one side of the first or second polymer substrate 20, 72 and the first, second and/or third security devices 30, 35, 81 may comprise an image array located on the opposing side of the first or second polymer substrate 20, 72. The first and/or second polymer substrate 20, 72 may therefore form an optical spacer between the focusing element array and image array.

The image array is preferably located in the focal plane of the focusing element array such that a substantially focused image of the image array is observable in the focusing element array when viewed in reflected light. Thus the thicknesses of the first and/or second polymer substrate 20, 72 and locations of the first, second and/or third security devices 30, 35, 81 must be carefully chosen to ensure that image array lies in the focal plane of the focusing element array. Preferably the distance between the image array and focal plane is within approximately 20% and more preferably approximately 10%, and even more preferably within approximately 5%, of the total focal length of at least one focusing element of the focusing element array.

The focusing element array comprises an array of elements capable of focusing visible light, such as lenses or mirrors, arranged over an area typically in a regular one-dimensional or two-dimensional grid. The focusing elements may be of any suitable form, such as cylindrical focusing elements, spherical focusing elements, aspherical focusing elements, elliptical focusing elements, Fresnel focusing elements and the like. The focusing elements may be concave or convex. The focusing elements can operate on refraction, diffraction or reflection (in the case of mirrors).

Preferably the focusing element array and image array combine to generate an optically variable effect, for example by forming one or more of a moiré magnifier, an integral imaging device or a lenticular device.

In a moiré magnifier the pitch, angular alignment or periodicity of microimages of an image array differs by a small degree to the pitch, angular alignment or periodicity of the elements of the focusing array and the mismatch results in magnified versions of the microimages being observable through the focusing element array. The magnification factor depends upon magnitude of the mismatch between the periodicities, pitches or angular alignment between the image array and focusing element array. Examples of moiré magnification devices are discussed in further detail in WO-A-2011/107788.

An integral imaging device is similar to a moiré magnifier, except that, instead of a mismatch between the image and focusing element arrays, each microimage is a view or elevation of the same object from different viewpoints. A three-dimensional image is observed by virtue of different microimages being observed as the security document 10, 70 is tilted. In a particular embodiment a hybrid moiré magnifier may be formed by combining the mismatch of a standard moiré magnifier with the different microimages of an integral imaging device.

In a lenticular device no magnification of the image array typically occurs. Instead the elements of the image array each comprises a section of a complete image and elements forming two or more complete images are interleaved or overlap one another. When viewed through the focusing element array, the different complete images will be visible at different viewing angles. Preferably the focusing element array comprises cylindrical elements in a lenticular device. Exemplary lenticular devices are disclosed in U.S. Pat. No. 4,892,336, WO-A-2011/051669, WO-A-2012/027779 and U.S. Pat. No. 6,856,462.

In FIG. 21 the first security device 30 comprises a focusing element array, in this case in the form of lenses, on the second outer surface 19 of the first polymer substrate 20 overlying a window 25 and the second security device 35 comprises an image array located on the opposing surface 38 of the adjacent page 12. The image array is observable through the focusing element array and first polymer substrate 20. The second security device 35 of the illustrated embodiment comprises second security elements 32 in the form of printed ink, although they have any other composition disclosed herein. The presence of the second polymer page 71 is optional in this embodiment in particular.

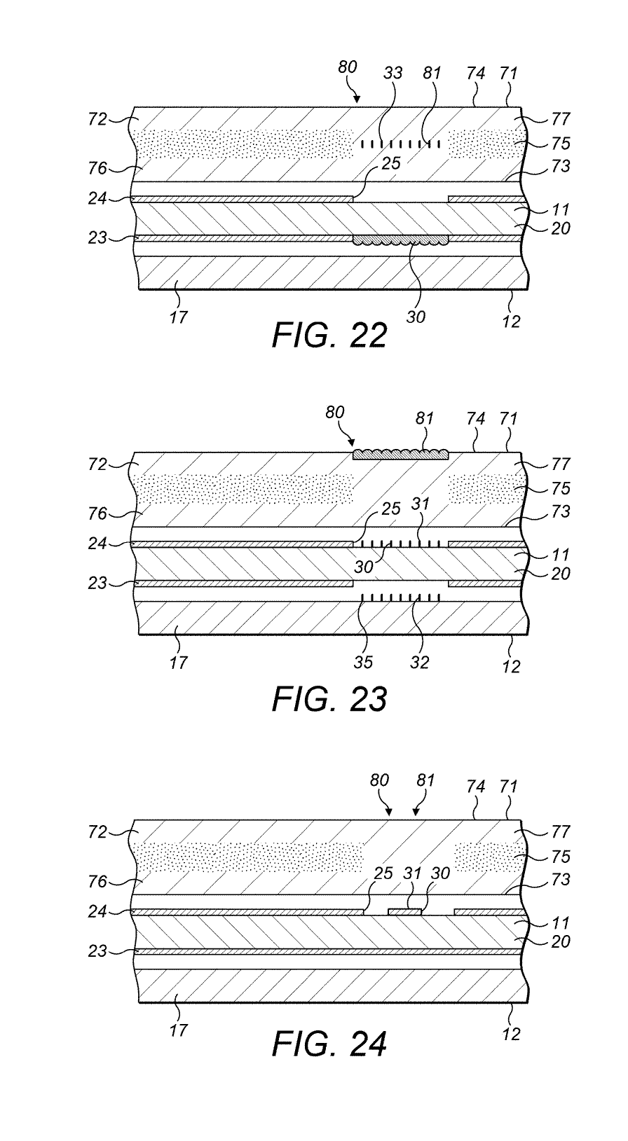

In FIG. 22 the first security device 30 comprises a focusing element array on the first outer surface 18 of the first polymer substrate 20 overlying a window 25 and the third security device 81 comprises an image array located within the window 80 in the second polymer substrate 72. The third security device 81 of the illustrated embodiment comprises third elements 33 in the form of laser markings, although they have any other composition disclosed herein. In the case of the focusing element array comprising lenses, the image array is observable through the focusing element array, first polymer substrate 20 and second polymer substrate 72. In the case of the focusing element array comprising mirrors, the focusing element array reflects light to present a magnified version of the underside of image array that is observable through the second polymer substrate 72 from the second outer surface 74.

In FIG. 23 the third security device 81 comprises a focusing element array located on the second outer surface 74 of the second polymer substrate 72 overlying the window 80. The first security device 30 comprises an image array located on the second outer surface 19, overlying the window 25, of the first polymer page 11 and the second security device 35, which is optionally present in this embodiment, comprises an image array located on the opposing surface 38 of the adjacent page 12. The first and second security devices 30, 35 of the illustrated embodiment comprise first and second security elements 31, 32 in the form of printed ink, although they have any other composition disclosed herein.

If located on the first polymer page 11, the focusing element array should have a focal length in the same range as the thickness of the first polymer page 11. The periodicity and therefore maximum base diameter (or width, in the case of elongate lenses) of the focusing elements is preferably in the range 5 to 200 μm, more preferably 10 to 100 μm and even more preferably 10 to 70 μm. The f number for the lenticular focusing elements is preferably in the range 0.1 to 16 and more preferably 0.5 to 4.

Instead of being directly applied to the first or second polymer substrate 20, 72, the focusing element array may be formed on a transparent support layer and the support layer may be applied to the first or second polymer substrate 20, 72 via the support layer. The support layer may be formed of the base substrate of the first or third security device 30, 81 and may comprise a transparent thread, strip, patch or foil. In any case the focusing elements array may be manufactured by, for example cast curing, printing a doming resin (such as those disclosed in U.S. Pat. No. 7,609,451 and US-A-2011/0116152) or by treating the surface of the support layer or first or second polymer substrate 20, 72 to vary its surface properties (as disclosed in US-A-20130071586).

The surface relief forming the focusing element array may also comprise protrusions extending between focusing elements away from the first or second polymer substrate 20, 71. The protrusions extend above the height of the focusing elements to separate the focusing elements from other features or the other pages 11, 12, 71 and thereby prevent and any damage or wear to the focusing elements.

Preferably each of the focusing elements is identical. However, the focusing element array could include elements with different optical properties, such as focal length, from one another. For example, the focusing element array could include lenses of different height from one another giving rise to different focal lengths in each region. Such an arrangement is particularly suitable in the embodiment of FIG. 32, as some focusing elements may focus upon the image array of the first security device 30 and some focusing elements may focus upon the image array of the second security device 35. Alternatively, a plurality of different lens heights could be arranged to form an image of the image array at different magnifications for each of the plurality of lens heights.

The image array is a graphic or the like or the like which comprises a pattern or microimages or image elements, each also being a graphic, pattern, indicium, alphanumeric character, symbol, logo or the like. The image array may be applied directly to the first polymer page 11, adjacent page 12 and/or, if present, the second polymer page 71 or, as discussed above, the first, second and/or third security device 30, 35, 81 may comprise a carrier substrate to which the image array is applied as the first, second or third elements 31, 32, 33. Alternatively, the image array may comprise laser marking within or on the first polymer page 11, adjacent page 12 and/or second polymer page 71 which is formed by directing laser light through the focusing element array.

The effectiveness of the optically generated effects discussed above may depend upon the resolution at which the image array can be observed through the focusing element array. The lines forming each image element must, therefore, be substantially smaller in width than the focusing elements. Printing techniques such as intaglio, gravure, wet lithographic printing, and dry lithographic printing can carefully be optimised to obtain printed ink with suitable line widths in the order of approximately 25 μm to approximately 50 μm. However, for smaller focusing elements the line widths are preferably less than 15 μm and more preferably less than 5 μm. WO-A-2005/052650 discloses a suitable technique for achieving such small dimensions. Alternatively, the technique disclosed in WO-A-2015/044671 may be used to form high resolution image arrays and the techniques disclosed in US-A-2009/0297805, WO-A-2011/102800 and WO-A-2014/070079 may be used to form microimages or micropatterns.

### E. The Personal Data

The personal data 15 is provided in or on the first polymer pages 11, the second polymer page 71 and/or the adjacent page 12 to form one or more data pages. In some embodiments the personal data 15 may be partially located on two or three of the first polymer page 11, the adjacent page 12 and the second polymer page 71. Some or all of the personal data 15, for example the holder's portrait 26, may be repeated on each of the first polymer page 11, adjacent page 12 and/or second polymer page 71.

The personal data 15 is known as “variable data” or “biographical data” and identifies the specific holder of the security document 10. The Seventh Edition (2015) of Document 9303 (“Machine Readable Travel Documents”) issued by the International Civil Aviation Organization (ICAO) describes such biographical data and its contents are incorporated herein by reference. Typically, no two security documents 10 issued by an issuing authority contain the same personal data 15.

The personal data 15 is typically applied to the first polymer page 11 and/or the adjacent page 12 by a printing process such as inkjet, xerography, gravure, offset, flexographic, lithographic or the like. A UV cure inkjet system is particularly suitable for printing the personal data 15 onto the first polymer substrate 20 and/or at least one opacifying layer 23, 24 of the first polymer page 11. Alternatively, one or more of the first and second opacifying layers 23, 24 may be laser ablated without damaging the first polymer substrate 20 using the method disclosed in EP-A-0961690, the contents of which are incorporated herein by reference. As a result, each element of the personal data 15 may form a full or half window in the first polymer page 11 (which are discussed in further detail below).

The personal data 15 may be at least partially formed from the first, second and/or third security devices 30, 81 and may be formed in any manner discussed above. In particular each element of personal data may be formed by the shapes of the outer perimeters of the at least one first, second and/or third elements 31, 32, 33 and/or carrier substrates.

Preferably the personal data 15 is applied to each of the first polymer page 11, the adjacent page 12 and/or the second polymer page 71 by different application techniques such that it has different compositions. In particular, the personal data 15 is applied to the second polymer page 71 in a manner which is not possible for the first polymer page 11. In particular, the personal data 15 and/or third security device 81 may comprise laser marking in the second polymer substrate 72 whilst the first polymer substrate 20 may not be laser markable due to its material properties and instead comprises personal data 15 in the form of printed ink.

The personal data 15 may be selectively viewable through the windows 25, 80 and be. For example some of the personal data 15 may be located on the first polymer page 11 such that is visible through the at least one window 80 of the second polymer page 71 when the first and second polymer pages 11, 71 are adjacent to one another. Alternatively, some of the personal data 15 may be located on the second polymer page 71 such that is visible through the at least one window 25 of the first polymer page 11 when the first and second polymer pages 11, 71 are adjacent to one another. Furthermore, some of the personal data 15 may be located on the adjacent page 12 such that it is visible through the windows 25, 80 when the first and second polymer pages 11, 71 and adjacent page 12 are adjacent to one another. In a particular embodiment the personal data 15 may be applied simultaneously and in register to the first and second polymer pages 11, 71 using laser ablation.

### F. Further Embodiments of the Security Document and Manufacture Thereof

Various alternatives to those described above also fall within the scope of the present invention. The security document 10, 70 may be of any suitable type having both the first polymer, second polymer and/or adjacent pages 11, 12, 71, and thus is preferably in a booklet format. In particular, the security document 10, 70 is a passbook, an identification document, a certificate, a licence, a cheque book and the like. Particularly preferably the security document 10, 70 is a passport, in that it is an official document issued by a government which certifies the holder's identity and citizenship and entitles them to travel across borders between countries. The passport may meet the requirements set out in Document 9303 issued by ICAO.

The security document 10 may comprise a plurality of each of the first and/or second polymer pages 11, 71 and may not comprise any adjacent pages 12 comprising fibrous substrate 17. The plurality of first and/or second polymer pages 11, 71 may each comprise the same or different first and third security devices 30, 81 arranged to interact with one another in windows 25, 80 which overlie one another when the plurality of first and/or second polymer pages 11, 71 are adjacent to one another.

Furthermore, the sequence of the first polymer page 11, adjacent page 12 and, if present, second polymer page 71 in the security document 10, 70 may differ to that set out above. For example, the second polymer page 71 comprising the second polymer substrate 72 may be located between the adjacent page 12 and the first polymer page 11 comprising the first polymer substrate 20. In any embodiment the security document 10, 70 may comprise an outer leaf 60 of fibrous substrate 17 adjacent to or adhered to the cover 13. The sequence illustrated in FIG. 5 is preferable as it improves the ease of manufacture of the security document 70 by enabling the binding of the first leaf 54, second leaf 55 and further leaves 56 prior to the addition of the third leaf 85.

The first, second and third security devices 30, 35, 81 are generally all visible in the at least one windows 25, 80. However, in embodiments the adjacent page 12 may not comprise a second security device 35 and may form a standard visa page 16. It is therefore emphasised that the terms “second” or “third” security devices 35, 81 do not refer to a requirement of the security document 10, 70 to have two or three different security devices 30, 35, 81. Instead, the terms “first”, “second” and “third” security devices 30, 35, 81 are used merely as nomenclature throughout the present disclosure. Instead, the first, second and/or third security devices 30, 35, 81 may be referred to as the first polymer page security device 30, the adjacent page security device 35 and/or the second polymer page security device 81 respectively.

The first polymer page 11 may comprise a plurality of windows 25, each with at least one first security device 30 located therein, and, if present, the second polymer page 71 may also comprise a plurality of windows 80, each with at least one third security device 81 located therein. Each of the plurality of windows 25, 80 may comprise no or different first or third security devices 30, 81 therein.

In the aforementioned embodiments the first and third security devices 30, 81 are located at least partially in the in the windows 25, 80 of the first and second polymer pages 11, 71. However, the at least one first and/or third security device 30, 81 may be located on the first and/or second polymer pages 11, 71 outside of the windows 25, 80. For instance, at least one first security device 30 may be located on at least one opacifying layer 23, 24 of the first polymer page 11 or between or within one of the plurality of layers of the second polymer page 71 overlapping the opaque region 75. The at least one first and/or third security device 30, 81 may still be visible in reflected light through at least one window 25, 80 of the second or first polymer page 11, 71 respectively when the first and second polymer pages 11, 71 overlie one another.

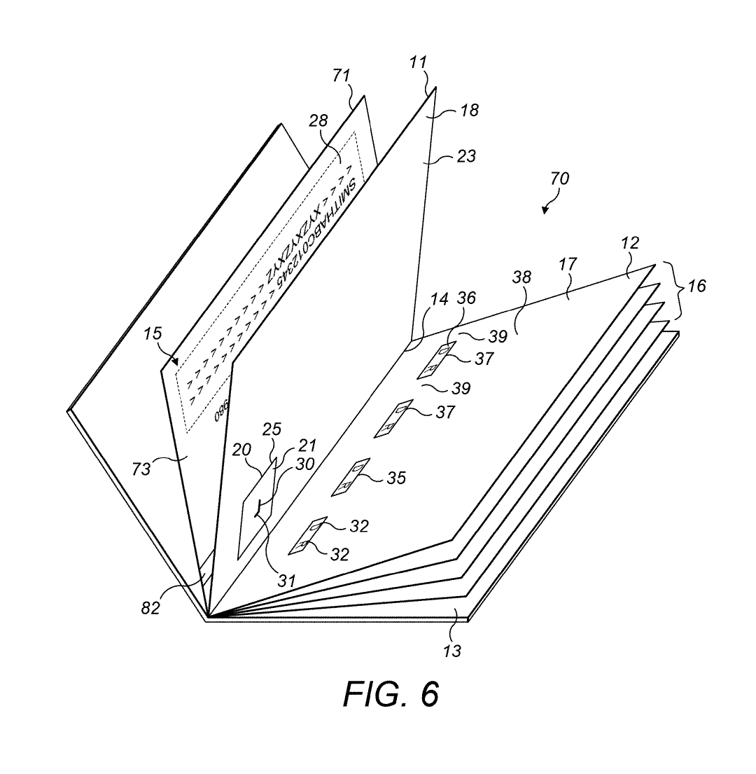

Furthermore, even though the at least one first and/or third security device 30, 81 are located outside of the windows 25, 80, they may be arranged such that they are viewable together in visible or non-visible reflected light when the first and second polymer pages 11, 71 are arranged to overlie one another. In particular, the at least one first or third security device 30, 81 is located such that it/they are visible from the surface of the first or second polymer page 11, 71 that is furthest from the second or first polymer page 71, 11 respectively. For instance, the first security device 30 may be located at or under the second outer surface 19 of the first polymer page 11 in the embodiment of FIG. 1 or located at or under the first outer surface 18 of the first polymer page 11 in the embodiment of FIG. 6. In the embodiment of FIG. 6 the third security device 81 may be located at or under the second outer surface 74 of the second polymer page 71. As a result, the first and third security devices 30, 81 may be viewed together for comparison to check their registration. The first and third security devices 30, 81 in such an arrangement are preferably comprised of repeated or separate parts of the personal data 15. In such an arrangement the first and third security devices 30, 81 may be of any of the kinds described above with any of the aforementioned registrations.

The perimeter of the at least one window 25, 80 may be any suitable shape, such as a recognisable pattern, indicium, alphanumeric character, symbol, logo (such as that of the issuing authority of the security document 10), graphic or the like. The term “recognisable” may refer to the shape conveying some form of intelligible information or data. The at least one window 25, 80 is substantially transparent such that light can pass through it and objects can be seen through it. The at least one window 80 may be clear, coloured or the like.

Furthermore, as illustrated in FIG. 24, the at least window 25 of the first polymer page 11 may be a “half” window. An opacifying layer 23, 24 is located on only one of the first and second substrate surfaces 21, 22 or the first and second opacifying layers 23, 24 cover non-opposing areas of the first and second substrate surfaces 21, 22. Thus the first opacifying layer 23 is absent from a localised area of the first substrate surface 21 and the second opacifying layer 24 is present on an opposing localised area of the second substrate surface 22 (or vice-versa). The localised area is preferably on the first or second substrate surface 21, 22, adjacent to the second polymer page 71. The first security device 30 may be located in this at least one half window 25 such that it is visible through the at least one window 80 of the second polymer page 71. Thus a half window would be less opaque than regions of the first polymer page 11 having first and second opacifying layers 23, 24 on the first and second substrate surfaces 21, 22, but less transparent than a full window 25. The at least one window 25 may comprise a combination of full and half windows and may be located within the edges of the first polymer page 11 or at one or more edges thereof. In a particular embodiment a full window may be located within, or at least partially overlap, a half window.

The first and/or second polymer pages 11, 71 may comprise further windows of a predefined shape located at and extending along at least one of their edges. In the case of the first polymer page 11, the at least one opacifying layer 23, 24 may be omitted from the first and/or second substrate surface 21, 22 adjacent to at least one edge. In the case of the second polymer page 71, the opaque region 75 may comprise a shape or the like along its edge and the further window may be formed according to the method disclosed above or in WO-A-2015/104011. Alternatively, the further window(s) may be formed by providing transparent portions of the first and second opaque layers 134, 135, the inlay 136 and/or the first intermediate layer 139.

The first and/or second polymer pages 11, 71 and/or adjacent page 12 may comprise any other suitable additional security features. The graphics, personal data 15 or other feature may comprise a printed ink and the ink may be luminescent, fluorescent, iridescent or the like. Other suitable security features may include at least one of a thread, strip, patch, hologram, kinegram or other diffractive element, iridescent or colour-shift material, microtext, fine line patterns, latent images, venetian blind devices, lenticular devices, moiré interference or magnification devices, watermarks, embossings, perforations or the like. Any conventional techniques for applying such components can be utilised, including casting of curable inks or resins onto the at least one opacifying layer 23, 24 and/or first polymer substrate 20, bonding by adhesives, lamination, hot stamping, transfer methods and the like.

The opaque region 75 of the second polymer page 71, particularly around the at least one window 80, preferably forms a uniform colour when viewed in the first and second outer surface 73, 74. In an embodiment the opaque region 75 is visible as a first colour at the first outer surface 73 and as a second colour at the second outer surface 74 when viewed in reflected light. For example, the second opaque layer 135 and first intermediate layer 139 may comprise different additives to form the different colours. Fluorescent additives may be selected such that the different colours are only apparent when the first and/or second outer surfaces 73, 74 are viewed in reflected UV light. The different colours may also be visible in the thickness of the second polymer page 71 (i.e. when viewed from the side), particularly if additives are included in the first opaque layer 134 and the inlay 136 and/or if the first and second opaque layers 134, 135, the inlay 136 and/or the first intermediate layer 139 are sufficiently thick.

Furthermore, in any of the examples above machine readable materials could be included in the first and/or second polymer substrates 20, 72 or the fibrous substrate 17. For example, the machine readable materials could be included in any of plurality of plastic layers 132 or the insert 142. Alternatively, they could comprise further machine readable layers or materials. The machine readable materials may contain detectable materials that react to an external stimulus, which may include but are not limited to fluorescent, phosphorescent, infrared absorbing, thermochromic, photochromic, magnetic, electrochromic, conductive and piezochromic materials.

1. A security document comprising a first polymer page adjacent to a second polymer page, the first polymer page comprising a first polymer substrate and the second polymer page comprising a second polymer substrate, wherein the first polymer substrate is of a different structure and/or material to the second polymer substrate and wherein the second polymer page is thicker than the first polymer page.

2. A security document as claimed in claim 1 wherein the first polymer substrate comprises a flexible film and/or the second polymer substrate comprises a rigid plastic sheet.

3. A security document as claimed in claim 1 wherein the second polymer substrate is formed from a plurality of plastic layers fused together.

4. A security document as claimed in claim 1 wherein the first polymer substrate comprises a different synthetic polymer to the second polymer substrate.

5. A security document as claimed in claim 4 wherein the second polymer substrate is laser markable and the first polymer substrate is not laser markable.

6. A security document as claimed in claim 1 wherein the first polymer substrate comprises at least one of polypropylene, bi-axially oriented polypropylene, polybutylene terephthalate, polyethylene terephthalate, polyethylene, polyvinyl chloride, nylon, acrylic, cyclic olefin polymer or cyclic olefin copolymer and blends thereof.

7. A security document as claimed in claim 1 wherein the second polymer substrate comprises polycarbonate.

8. A security document as claimed in claim 1 wherein the first polymer page comprises at least one opacifying layer on at least one surface of the first polymer substrate.

9. A security document as claimed in claim 1 wherein the second polymer substrate comprises first and second outer surfaces, at least one substantially transparent region adjacent the first and/or second outer surface and a substantially opaque region located separated from the first and/or second outer surface by the at least one substantially transparent region.

10. A security document as claimed in claim 1 wherein the thickness of the first polymer page is in the range of from approximately 50 μm to approximately 200 μm or from approximately 50 μm to approximately 150 μm and/or the thickness of the second polymer substrate is at least approximately 300 μm, at least approximately 500 μm or at least approximately 800 μm.

11. A security document as claimed in claim 1 wherein the first and/or second polymer page comprises personal data.

12. A security document as claimed in claim 11 wherein personal data on the first polymer page is of a different composition to personal data on the second polymer page by virtue of being applied by a different application method.

13. (canceled)

14. A security document as claimed in claim 1 wherein the first polymer page comprises at least one first security device, the second polymer page comprises at least one third security device and, if present, an adjacent page comprises at least one second security device.

15. A security document as claimed in claim 1 wherein the first and/or second polymer page comprises at least one window of at least partially transparent first and/or second polymer substrate.

16-20. (canceled)

21. A security document as claimed in claim 15 wherein at least one window in the first or second polymer page is smaller than at least one adjacent window in the second or first polymer page.

22. A security document as claimed in claim 1 further comprising a plurality of pages, each comprising a fibrous substrate, adjacent to the first or second polymer page.

23. A security document as claimed in claim 1 wherein the first and second polymer page, and, if present, plurality of pages, are attached to one another along a fold line.

24. A security document as claimed in claim 1, further comprising a plurality of pages,
wherein each of the plurality of pages further comprise a fibrous substrate, adjacent to the first polymer page or second polymer page;
wherein the first polymer page and second polymer page and the plurality of pages are attached to one another along a fold line;
wherein the plurality of pages further comprise a plurality of visa pages that form a passport.

25. A plurality of security documents as claimed in claim 11 wherein each security document comprises different personal data.

26. A method of manufacturing a security document of claim 1 comprising forming the first polymer page from a web of film, forming the second polymer page by fusing a plurality of plastic layers together in a laminator and incorporating the first polymer page and second polymer page into a security document.

27-69. (canceled)
